(19) United States
(12) Patent Application Publication
(10) Pub. No.: US 2016/0111785 A1
(43) Pub. Date: Apr. 21, 2016

(54) MULTI-BAND ANTENNA SYSTEM

(71) Applicant: GOODTELL. CO., LTD., Anyang-si, Gyeonggi-do (KR)

(72) Inventor: Jinyoung PARK, Seoul (KR)

(21) Appl. No.: 14/894,529

(22) PCT Filed: Oct. 25, 2013
(86) PCT No.: PCT/KR2013/009552

§ 371 Date: Nov. 29, 2015

(30) Foreign Application Priority Data
May 29, 2013 (KR) 10-2013-0060755
May 29, 2013 (KR) 10-2013-0060756

(51) Int. Cl. H01Q 5/50

(52) U.S. Cl. CPC H01Q 5/50

(57) ABSTRACT

The present invention relates to a multiband antenna system and, more particularly, to a multiband antenna system which performs beam tilt while servicing a multiband with a broadband radiating element supporting a multiband. The multiband antenna system according to the present invention comprises: at least one broadband radiating element; a branching filter; and a plurality of phase shifters. The at least one broadband radiating element supports a multiband. The branching filter is connected to each of the at least one broadband radiating element and branches signals per band included in the multiband. The plurality of phase shifters are provided to correspond to the number of the multibands and perform beam tilt for the signals branched per band in accordance with each band. Here, the band means not a band for dividing receipt and transmission in a particular band, but a service band per service provider.

### CROSS REFERENCE TO RELATED APPLICATIONS

This application claims the priority of Korean Patent Application No. 10-2013-0060755 filed on May 29, 2013 and Korean Patent Application No. 10-2013-0060756 filed on May 29, 2013 in the Korean Patent and Trademark Office. Further, this application is the National Phase Entry of International Application No. PCT/KR2013/009552 filed on Oct. 25, 2013, which is incorporated herein by reference in its entirety.

### TECHNICAL FIELD

The present invention relates to a multiband antenna system, and more particularly, to a multiband antenna system capable of beam tilting while serving multiple bands with a broadband radiating element supporting the multiple bands.

### BACKGROUND ART

Due to diversification of communication services, one service provider is allocated a plurality of frequency bands and uses the plurality of frequency bands. Therefore, when a base station or a relay station is installed, antennas according to frequency bands of respective services are installed.

Accordingly, antennas according to a plurality of service bands of a plurality of service providers are installed in a steel tower of a base station or a relay station, but there is a limitation on the number of antennas that can be installed on a steel tower having limited space. Also, when an excessive number of antennas are installed on a steel tower, they serve as factors that spoil a beautiful urban landscape.

To reduce such problems, service providers use multiband antennas with each of which two or more frequency bands can be served.

For example, to implement a dual-band antenna for a base station, a method of arranging radiating elements supporting respective bands to overlap or arranging the radiating elements in a horizontal direction or a vertical direction is generally used. In other words, when there is a large difference in frequency band between a low band and a high band and one wavelength is about double the other wavelength, a radiating element supporting the low band and a radiating element supporting the high band are arranged to overlap. In this case, it is possible to reduce the overall size of an antenna.

However, when the difference in frequency band between the low band and the high band is not large and one wavelength is about double the other wavelength or less, for example, in the case of a 700 MHz band and a 900 MHz band and in the case of a 1.8 GHz band and a 2.1 GHz band, a low band antenna and a high band antenna are arranged horizontally or vertically. In this case, the overall size of an antenna becomes large, thus causing several problems, such as a large installation space occupied by the antenna upon provision of a base station, and so on.

Meanwhile, in a wireless communication system, subscribers' frequencies of use vary according to region or time, and thus a communication environment of subscribers having high frequencies of use is degraded compared to that of subscribers having low frequencies of use.

To solve these problems and provide an optimal service, a network management method in which the angle of a radiation beam of a base station antenna is adjusted to control the base station coverage is being used. As a method for adjusting (tilting) the angle of a radiation beam of an antenna, mechanical or electrical beam tilting is in use.

Mechanical beam tilting may reduce production costs. However, according to mechanical beam tilting, an engineer should directly adjust a beam tilt of an antenna using a tilting tool connected to an antenna which is installed at a high place. Therefore, there is a high risk of a safety accident in which an engineer falls from the installation place on an antenna, and it takes a long time to adjust a beam tilt.

According to electrical beam tilting, a beam tilt of an antenna is remotely adjusted. Therefore, there is no risk of a safety accident in which an engineer falls from the installation place of an antenna, and it is possible to rapidly adjust a beam tilt.

In an antenna system capable of such electrical beam tilting, a phase shifter which changes the phase of a radiation beam is installed. In other words, the phase shifter changes the phase of a signal by changing the length of a transmission line through which the signal passes.

Most currently used phase shifters have a structure in which a rotating arm rotates based on an arc.

Such an arc-based phase shifter is designed based on a T-junction, and thus has a problem in that isolation of output ends is not ensured.

For example, when an input end is defined as P1 and output ends are defined as P2 and P3 in an arc-based phase shifter, it is possible to see that S22 and S23 characteristics among scattering (S)-parameter characteristics have a value of about −6 dB. This indicates that isolation of P2 and P3 is not ensured. In other words, when the lengths of paths to P2 and P3 change due to the rotation of a rotating arm, the amplitude and the phase of S21 drastically change in value. Due to such a characteristic, when a radiating element or another component is present at the rear end of a port, a unique characteristic of the other component installed at the rear end of the port is distorted by the interference between ports.

When an arc-based phase shifter is applied to an array antenna, such a characteristic distorts an amplitude and a phase supplied to each radiating element, and it is difficult to obtain a desired radiation pattern.

Also, to increase a phase variance of an arc-based phase shifter, the size (area) of the phase shifter exponentially increases. Specifically, since a radius from a rotating portion of a rotating arm should double to obtain a desired displacement, the arc-based phase shifter increases in size.

For example, when four ports or five ports are implemented in a phased array antenna, an arc should be formed based on the center point of a rotating arm so that phases sequentially enter the ports. Specifically, in the case of five ports, a length ratio to the center of the rotating arm should be 2:1, and in the case of four ports, a length ratio should be 3:1, and thus the size becomes rather large. This causes phase shifters used in the same frequency band to have different sizes, and an increase in production costs.

### DISCLOSURE

### Technical Problem

To solve these problems, a method of broadening the band of a radiating element so that one antenna can transmit and receive two frequency bands, for example, a 700 MHz band and a 900 MHz band or a 1.8 GHz band and a 2.1 GHz band can be taken into consideration.

However, an antenna having such a broadband radiating element supporting multiple bands cannot control beams for the respective bands, and thus it is not possible to optimize each service coverage.

Therefore, the present invention is directed to providing a multiband antenna system capable of beam tilting while serving multiple bands with a broadband radiating element supporting the multiple bands.

The present invention is also directed to providing a phase shifter employing a Wilkinson divider and capable of solving problems of an arc-type phase shifter based on a T-junction.

The present invention is also directed to providing a phase shifter employing a Wilkinson divider and capable of ensuring isolation between respective output ports.

The present invention is also directed to providing a phase shifter employing a Wilkinson divider and capable of minimizing an increase in the size of the phase shifter even when a phase variance increases.

The present invention is also directed to providing a phase shifter employing a Wilkinson divider and capable of coping with band broadening.

The present invention is also directed to providing a phase shifter employing a Wilkinson divider and capable of preventing a distortion of a unique characteristic of a component or a distortion of a phase signal even when the component is added to the back of the phase shifter.

The present invention is also directed to providing a phase shifter employing a Wilkinson divider and capable of solving the problem of a distorted amplitude and phase supplied to each radiating element even when applied to an array antenna.

### Technical Solution

One aspect of the present invention provides a multiband antenna system including at least one broadband radiating element, a branching filter, and a plurality of phase shifters. Here, the at least one broadband radiating element supports multiple bands. The branching filter is connected to each of the at least one broadband radiating element, and branches band-specific signals included in the multiple bands. The plurality of phase shifters are provided to correspond to a number of the multiple bands, and perform beam tilting for the branched band-specific signals according to the respective bands.

In the multiband antenna system, the branching filter may be a diplexer or a triplexer.

In the multiband antenna system, when the broadband radiating element supports two bands, the branching filter may be a diplexer or a triplexer. When the broadband radiating element supports three bands, the branching filter may be a triplexer.

In the multiband antenna system, when the broadband radiating element supports two bands, the phase shifters may include two phase shifters separately supporting the two bands. When the broadband radiating element supports three bands, the phase shifters may include three phase shifters separately supporting the three bands.

In the multiband antenna system, the phase shifters may include a base substrate and a variable substrate. In the base substrate, an input port and a plurality of output ports may be formed, and a plurality of first transmission lines connecting the input port with the plurality of output ports through at least one Wilkinson divider may be discontinuously formed. In the variable substrate, a plurality of second transmission lines separately connected to the plurality of first transmission lines to constitute continuous transmission lines may be formed, and the variable substrate may be combined with the base substrate and moved to change lengths of the transmission lines between the input port and the plurality of output ports.

In the multiband antenna system, the base substrate may have an input port and a plurality of output ports. The base substrate may include at least one Wilkinson divider connected to the input port, and each of the at least one Wilkinson divider may have two connection ports. In the base substrate, one pair of first transmission lines may be discontinuously formed to be symmetrical to each other at the two connection ports. In the base substrate, the plurality of output ports may be separately connected to ends of the first transmission lines.

In the multiband antenna system, the variable substrate may be combined with the base substrate to be movable, and second transmission lines physically coming in contact with the first transmission lines to continuously connect the discontinuously formed first transmission lines may be formed in the variable substrate, and may overlap the first transmission lines to change lengths of the transmission lines between the input port and the plurality of output ports according to movement of the variable substrate.

In the multiband antenna system, the Wilkinson divider may include a first interconnection, two connection ports, and a resistor. A signal may be input to the first interconnection. The two connection ports may be separately formed at two second interconnections symmetrically branching from the first interconnection. The resistor may connect the two connection ports.

In the Wilkinson divider of the multiband antenna system, the two connection ports may be positioned adjacent to each other based on a point at which the first interconnection branches, and the two connection ports adjacent to each other may be connected through the resistor.

In the multiband antenna system, the base substrate may include one Wilkinson divider. Here, the first interconnection of the Wilkinson divider may be connected to the input port, and the one pair of first transmission lines may be separately connected to the second interconnections extending from the two connection ports.

In the multiband antenna system, the base substrate may include first to third Wilkinson dividers. Here, the first interconnection of the first Wilkinson divider may be connected to the input port, and the first interconnections of the second and third Wilkinson dividers may be separately connected to the second interconnections extending from the two connection ports of the first Wilkinson divider. One pair of 1-1^{st} transmission lines may be separately connected to the second interconnections extending from the two connection ports of the second Wilkinson divider. One pair of 1-2^{nd} transmission lines may be separately connected to the second interconnections extending from the two connection ports of the third Wilkinson divider.

Another aspect of the present invention provides a phase shifter for an antenna including a base substrate and a variable substrate. In the base substrate, an input port and a plurality of output ports are formed, and a plurality of first transmission lines connecting the input port with the plurality of output ports through at least one Wilkinson divider are discontinuously formed. In the variable substrate, a plurality of second transmission lines separately connected to the plurality of first transmission lines to constitute continuous transmission lines may be formed, and the variable substrate may be combined with the base substrate and moved to change lengths of the transmission lines between the input port and the plurality of output ports.

In the phase shifter for an antenna system, the base substrate may have an input port and a plurality of output ports. The base substrate may include at least one Wilkinson divider connected to the input port, and each of the at least one Wilkinson divider may have two connection ports. In the base substrate, one pair of first transmission lines may be discontinuously formed to be symmetrical to each other at the two connection ports. In the base substrate, the plurality of output ports may be separately connected to ends of the first transmission lines.

In the phase shifter for an antenna system, the variable substrate may be combined with the base substrate to be movable, and second transmission lines physically coming in contact with the first transmission lines to continuously connect the discontinuously formed first transmission lines may be formed in the variable substrate, and may overlap the first transmission lines to change lengths of the transmission lines between the input port and the plurality of output ports according to movement of the variable substrate.

In the phase shifter for an antenna system, the Wilkinson divider may include a first interconnection, two connection ports, and a resistor. A signal may be input to the first interconnection. The two connection ports may be separately formed at two second interconnections symmetrically branching from the first interconnection. The resistor may connect the two connection ports.

In the Wilkinson divider of the phase shifter for an antenna system, the two connection ports may be positioned adjacent to each other based on a point at which the first interconnection branches, and the two connection ports adjacent to each other may be connected through the resistor.

In the phase shifter for an antenna system, the base substrate may include one Wilkinson divider. Here, the first interconnection of the Wilkinson divider may be connected to the input port, and the one pair of first transmission lines may be separately connected to the second interconnections extending from the two connection ports.

In the phase shifter for an antenna system, the first transmission lines of the base substrate may include start transmission lines connected to the second interconnections extending from the connection ports and extending in a horizontal direction, and end transmission lines formed in parallel with the start transmission lines and connected to the output ports. Here, the second transmission lines may connect the start transmission lines and the end transmission lines which are not connected, and have portions overlapping the start transmission lines and the end transmission lines.

In the phase shifter for an antenna system, the first transmission lines of the base substrate may further include at least one connecting transmission line formed between the start transmission lines and the end transmission lines and having a “⊃” shape.

In the phase shifter for an antenna system, the second transmission lines may include at least one overlapping transmission line having a “⊂” shape to connect the discontinuously formed first transmission lines, and when a number of the connecting transmission line is n (n is an integer equal to or larger than 0), a number of the at least one overlapping transmission line may be n+1.

The phase shifter for an antenna system may further include a moving member configured to move the variable substrate, with respect to the base substrate, in a linear direction parallel to a direction in which the start transmission lines are formed.

In the phase shifter for an antenna system, the moving member may include a rotation shaft formed in the base substrate and installed to be rotatable, a moving shaft installed in the variable substrate, and a moving bar configured to connect the rotation shaft and the moving shaft and move the moving shaft in the linear direction from the rotation shaft by externally applied force.

In the phase shifter for an antenna system, the moving shaft may be installed to connect a guide hole formed in parallel with the start transmission lines formed in a horizontal direction on the base substrate and a hole corresponding to the guide hole and formed in the variable substrate. According to operation of the moving bar, the moving shaft may make a linear movement.

In the phase shifter for an antenna system, the moving member may further include a dummy shaft installed spaced apart from the moving shaft in the variable substrate. Here, the dummy shaft may be installed to connect a dummy guide hole formed in parallel with the guide hole and in the horizontal direction in the base substrate and a hole corresponding to the dummy guide hole and formed in the variable substrate. According to operation of the moving bar, the dummy shaft may make a linear movement along the dummy guide hole together with the moving shaft.

In the phase shifter for an antenna system, the base substrate may include first to third Wilkinson dividers. Here, the first interconnection of the first Wilkinson divider may be connected to the input port, and the first interconnections of the second and third Wilkinson dividers may be separately connected to the second interconnections extending from the two connection ports. One pair of 1-1^{st} transmission lines may be separately connected to the second interconnections extending from the two connection ports of the second Wilkinson divider. One pair of 1-2^{nd} transmission lines may be separately connected to the second interconnections extending from the two connection ports of the third Wilkinson divider.

In the phase shifter for an antenna system, the variable substrate may include a first variable substrate and a second variable substrate. In the first variable substrate, 2-1^{st} transmission lines connected to the second Wilkinson divider may be formed. The second variable substrate may be separated from the first variable substrate, and 2-2^{nd} transmission lines disposed symmetrically to the 2-1^{st} transmission lines connected to the second Wilkinson divider and connected to the third Wilkinson divider may be formed. Here, the second transmission lines may include the 2-1^{st} transmission lines and the 2-2^{nd} transmission lines.

In the phase shifter for an antenna system, the second and third Wilkinson dividers may be formed to face each other on two sides based on the first Wilkinson divider in the base substrate. In the base substrate, two second connection ports of the second Wilkinson divider may be formed on one side based on a direction in which two first connection ports of the first Wilkinson divider are formed, and two third connection ports of the third Wilkinson divider may be formed on another side.

In the phase shifter for an antenna system, the 1-1^{st} transmission lines of the base substrate may include first start transmission lines connected to the second interconnections extending from the second connection ports and extending in the horizontal direction, and first end transmission lines formed in parallel with the first start transmission lines and connected to first output ports. Here, the 2-1^{st} transmission lines may connect the first start transmission lines and the first end transmission line which are not connected, and have portions overlapping the first start transmission lines and the first end transmission lines.

In the phase shifter for an antenna system, the 1-2^{nd} transmission line of the base substrate may include second start transmission lines connected to the second interconnections extending from the third connection ports and extending in the horizontal direction, and a second end transmission line formed in parallel with the second start transmission lines and connected to second output ports. Here, the 2-2^{nd} transmission line may connect the second start transmission lines and the second end transmission line which are not connected, and have portions overlapping the second start transmission lines and the second end transmission lines.

In the phase shifter for an antenna system, the 1-1^{st} transmission lines of the base substrate may further include at least one first connecting transmission line formed between the first start transmission lines and the first end transmission line and having a “⊃” shape.

Also, the 1-2^{nd} transmission lines of the base substrate may further include at least one second connecting transmission line formed between the second start transmission lines and the second end transmission line and having a “⊃” shape.

In the phase shifter for an antenna system, the 2-1^{st} transmission lines may have a “⊂” shape to connect the discontinuously formed 1-1^{st} transmission lines and include at least one first overlapping transmission line, and when a number of the first connecting transmission line is n (n is an integer equal to or larger than 0), a number of the first overlapping transmission line may be n+1.

Also, the 2-2^{nd} transmission line may have a “⊂” shape to connect the discontinuously formed 1-2^{nd} transmission lines and include at least one second overlapping transmission line, and when a number of the second connecting transmission line is n, a number of the at least one second overlapping transmission line may be n+1.

The phase shifter for an antenna system may further include a moving member configured to move the first and second variable substrates with respect to the base substrate in a linear direction, that is, opposite directions, parallel to a direction in which the first start transmission lines are formed.

In the phase shifter for an antenna system, the moving member may include a rotation shaft, a first moving shaft, a second moving shaft, and a moving bar. The rotation shaft may be formed in the base substrate and installed to be rotatable. The first moving shaft may be installed in the first variable substrate. The second moving shaft may be installed in the second variable substrate. The moving bar may connect the rotation shaft and the first and second moving shafts and move the first and second moving shafts in opposite linear directions based on the rotation shaft by externally applied force.

In the phase shifter for an antenna system, the rotation shaft, the first moving shaft, and the second shaft may be positioned in one line, and distances from the rotation shaft to the first and second moving shafts may differ from each other.

In the phase shifter for an antenna system, the first moving shaft may be installed to connect a first guide hole formed in parallel with the first start transmission lines formed in the horizontal direction in the base substrate and a first hole corresponding to the first guide hole and formed in the first variable substrate.

Also, the second moving shaft may be installed to connect a second guide hole formed in parallel with the second start transmission lines formed in the horizontal direction in the base substrate and a second hole corresponding to the second guide hole and formed in the second variable substrate.

According to operation of the moving bar, the first and second moving shaft may make linear movements in opposite directions along the first and second guide holes.

### Advantageous Effects

A multiband antenna system according to the present invention branches band-specific signals transmitted and received by a broadband radiating element supporting multiple bands through a branching filter, and performs beam tilting for the branched band-specific signals according to the respective bands through phase shifters, thereby optimizing each service coverage.

In a multiband antenna system according to the present invention, it is unnecessary to install band-specific antennas for a multiband service, and it is possible to reduce the number of installations of antennas.

In a phase shifter according to the present invention, a Wilkinson divider is used to connect an input port and a plurality of output ports, thus solving a problem of an arc-type phase shifter based on a T-junction. In other words, since the phase shifter employs the Wilkinson divider, it is possible to ensure isolation between the respective output ports.

In a phase shifter according to the present invention, it is only necessary to increase the vertical and horizontal lengths of first and second transmission lines so as to increase a phase variance. Therefore, even when the phase variance is increased, it is possible to minimize an increase in size.

In a phase shifter according to the present invention, it is possible to ensure isolation between output ports using a Wilkinson divider. Therefore, it is unnecessary to separately install phase shifters according to respective bands, and it is possible to cope with band broadening.

In a phase shifter according to the present invention, it is possible to ensure isolation between output ports using a Wilkinson divider. Therefore, it is possible to prevent a distortion of a unique characteristic of a component or a distortion of a phase signal even when the component is added to the back of the phase shifter.

In a phase shifter according to the present invention, it is possible to ensure isolation between output ports using a Wilkinson divider. Therefore, it is possible to solve the problem of a distorted amplitude and phase supplied to each radiating element even when the phase shifter is applied to an array antenna.

### DESCRIPTION OF DRAWINGS

FIG. 1 is a block diagram of a multiband antenna system according to a first exemplary embodiment of the present invention.

FIG. 2 is a block diagram of a multiband antenna system according to a second exemplary embodiment of the present invention.

FIG. 3 is a block diagram of a multiband antenna system according to a third exemplary embodiment of the present invention.

FIG. 4 is an exploded perspective view of a first example of a phase shifter that can be applied to a multiband antenna system according to the present invention.

FIG. 5 is a perspective view of the phase shifter of FIG. 4.

FIGS. 6 to 8 are diagrams showing examples of use of the phase shifter of FIG. 5.

FIG. 9 is a graph showing a scattering (S)-parameter of the phase shifter of FIG. 5 in a 700 MHz band and a 900 MHz band.

FIGS. 10A through 10C are graphs showing an S-parameter of a multiband antenna system employing an arc-based phase shifter according to a comparative example in a 700 MHz band.

FIGS. 11A through 11C are graphs showing an S-parameter of a multiband antenna system employing a phase shifter according to a first example of the present invention in a 700 MHz band.

FIG. 12 is an exploded perspective view of a phase shifter using Wilkinson dividers according to a second example of the present invention.

FIG. 13 is an enlarged view of the Wilkinson dividers of FIG. 12.

FIG. 14 is a perspective view of the phase shifter of FIG. 12.

FIGS. 15 to 17 are diagrams showing examples of use of the phase shifter of FIG. 14.

### MODES OF THE INVENTION

It is to be noted that in the following descriptions, only portions required to understand the present invention will be described and the description of portions other than the required portions which may obscure the gist of the present invention will be omitted.

The terminology or words used in this specification and the claims described below should not be interpreted as typical meanings or lexical meanings, and they should be interpreted as the meaning and concept conforming to the technological spirit of the present invention according to the principle that the inventor can define the concept of the words appropriately in order to illustrate his or her invention in the best manner. Therefore, embodiments disclosed herein and constitutions illustrated in drawings are merely preferable embodiments of the present invention, and do not represent all the technological spirit of the present invention. Accordingly, it should be appreciated that there may be various equivalents and modifications for substituting those at the time point of filing this application.

Hereinafter, exemplary embodiment of the present invention will be described in detail with reference to the accompanying drawings.

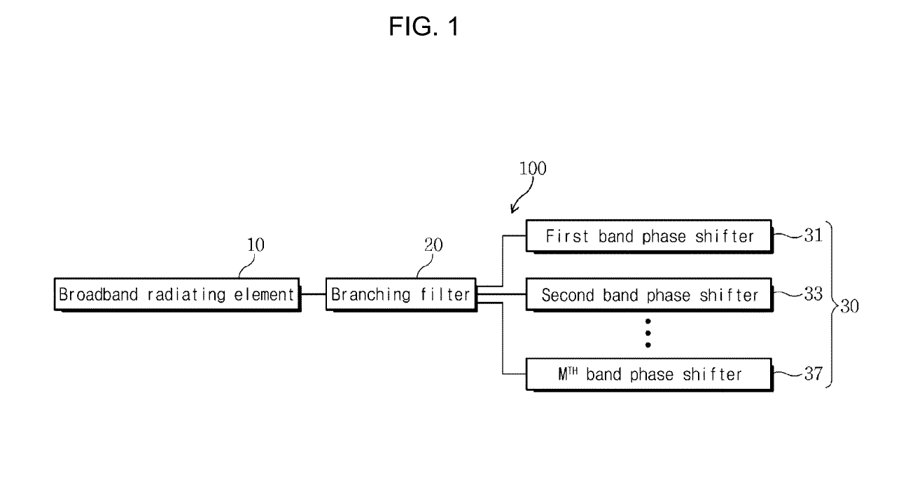

FIG. 1 is a block diagram of a multiband antenna system according to a first exemplary embodiment of the present invention.

Referring to FIG. 1, a multiband antenna system 100 according to the first exemplary embodiment of the present invention includes a broadband radiating element 10, a branching filter 20, and a plurality of phase shifters 30. Here, the broadband radiating element 10 is a radiating element supporting multiple bands. The branching filter 20 is connected to the broadband radiating element 10, and branches band-specific signals included in the multiple bands. The plurality of phase shifters 30 are provided to correspond to the number of multiple bands, and perform beam tilting for the branched band-specific signals according to the respective bands.

The multiband antenna system 100 according to the first exemplary embodiment will be described in detail below.

The multiple bands supported by the broadband radiating element 10 include two or more bands. The bands do not represent bands for distinguishing between transmission and reception in a specific band, but represent service bands according to service providers. For example, the bands include an 800 MHz band, a 900 MHz band, a 1.8 GHz band, a 2.1 GHz band, and a 2.3 GHz band, and the multiple bands include two or more of the aforementioned bands. Here, the broadband radiating element 10 can support two or three service bands.

The branching filter 20 branches band-specific signals included in the multiple bands supported by the broadband radiating element 10. As the branching filter 20, a diplexer or a triplexer can be used. For example, when the broadband radiating element 10 supports two bands, a diplexer or a triplexer can be used as the branching filter 20. When the broadband radiating element 10 supports three bands, a triplexer can be used as the branching filter 20.

Assuming that the broadband radiating element 10 is installed on the front surface of a reflecting plate, the branching filter 20 can be installed on the rear surface of the reflecting plate.

Here, the diplexer is a device that transfers signals separately output from two circuits (phase shifters) to one circuit (broadband radiating element) without the signals affecting each other, or transfers signals output from one circuit (broadband radiating element) to two circuits (phase shifters) without the signals affecting each other. Such a diplexer represents a branching filter that is frequently used to simultaneously transmit and receive two signals having different frequencies. The diplexer is only required to perform band separation on two signals having an apparent frequency difference, thus generally having a simple structure in which a low band filter (LBP) through which a low frequency signal passes and a high band filter (HBP) through which a high frequency signal passes are combined.

The triplexer is a passive filter element that separates three frequency bands. In the triplexer, low pass, band pass, and high pass filters are integrated, and thus the triplexer can separately pass three frequencies at the same time.

The phase shifters 30 are provided to correspond to the number of multiple bands, and perform beam tilting for the branched band-specific signals according to the respective bands. When the number of multiple bands is m, the phase shifters 30 include m (m is a natural number equal to or larger than 2) phase shifters 31, 33, . . . , and 37. In other words, the multiband antenna system 100 according to the first exemplary embodiment includes first, second, . . . , and m^{th} band phase shifters 31, 33, . . . , and 37.

In this way, the multiband antenna system 100 according to the first exemplary embodiment branches band-specific signals transmitted and received by the broadband radiating element 10 supporting multiple bands through the branching filter 20, and performs beam tilting for the branched band-specific signals according to the respective bands through the phase shifters 30, thereby optimizing each service coverage.

Also, the multiband antenna system 100 according to the first exemplary embodiment does not require installation of band-specific antennas for a multiband service, thus reducing the number of installation of antennas.

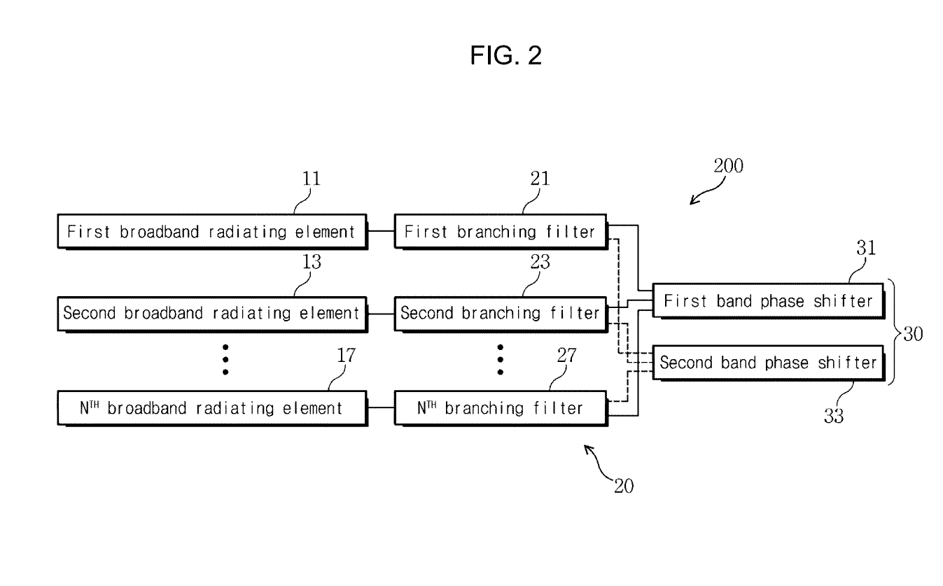

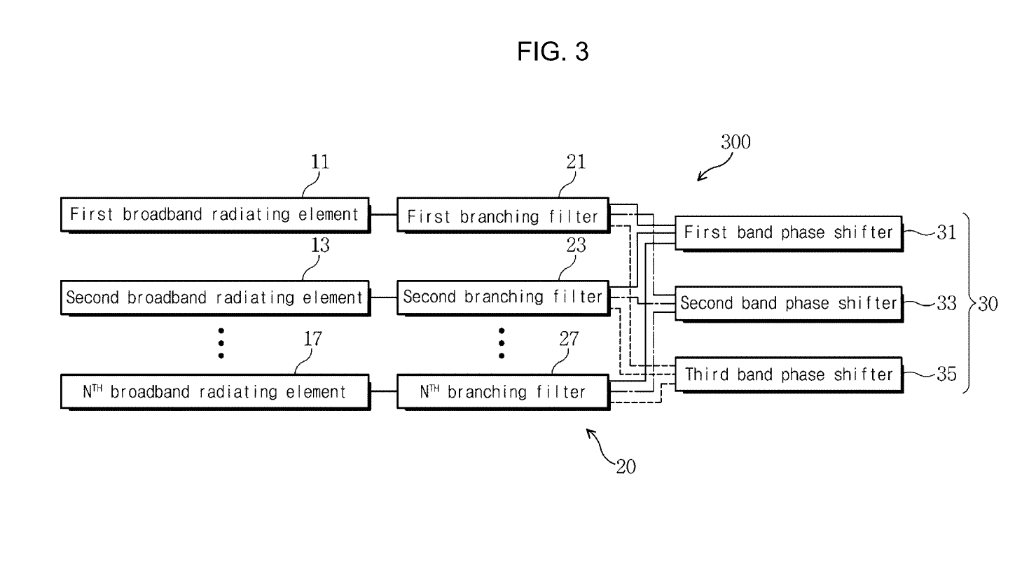

Meanwhile, the first exemplary embodiment discloses the multiband antenna system 100 including one broadband radiating element 10, but the present invention is not limited thereto. For example, as shown in FIGS. 2 and 3, it is possible to implement multiband antenna systems 200 and 300 including a plurality of broadband radiating elements 10.

FIG. 2 is a block diagram of the multiband antenna system 200 according to a second exemplary embodiment of the present invention.

Referring to FIG. 2, the multiband antenna system 200 according to the second exemplary embodiment is an antenna system supporting two bands, including a plurality of broadband radiating elements 10, a plurality of branching filters 20, and a plurality of phase shifters 30.

Here, the branching filters 20 are connected to the plurality of broadband radiating elements 10 to correspond to each other on a one-to-one basis. Therefore, when the number of broadband radiating elements 10 is n (n is a natural number equal to or larger than 2), n branching filters 20 are used. The broadband radiating elements 10 according to the second exemplary embodiment support two bands. For example, the two bands may be a 700 MHz band and a 900 MHz band or a 1.8 GHz band and a 2.1 GHz band. The multiband antenna system 200 according to the second exemplary embodiment includes first, second, . . . , n^{th} broadband radiating elements 11, 13, . . . , and 17.

As the branching filters 20, diplexers or triplexers can be used. The second exemplary embodiment discloses an example in which diplexers capable of separating two bands are used as the branching filters 20. For example, the multiband antenna system 200 according to the second exemplary embodiment includes first, second, . . . , n^{th} branching filters 21, 23, . . . , and 27.

The plurality of phase shifters 30 include first and second band phase shifters 31 and 33. The first band phase shifter 31 performs electrical tilting on a signal included in a first band between two bands separated by the plurality of branching filters 20. The second band phase shifter 33 performs electrical tilting on a signal included in a second band between the two bands separated by the plurality of branching filters 20. For example, the first band phase shifter 31 may perform a phase shift on a signal in a 700 MHz band, and the second band phase shifter 33 may perform a phase shift on a signal in a 900 MHz band.

Therefore, the multiband antenna system 200 according to the second exemplary embodiment branches band-specific signals transmitted and received by the broadband radiating elements 10 supporting multiple bands through the branching filters 20, and performs beam tilting for the branched band-specific signals according to the respective bands through the first and second band phase shifters 31 and 33, thereby optimizing each service coverage.

FIG. 3 is a block diagram of the multiband antenna system 300 according to a third exemplary embodiment of the present invention.

Referring to FIG. 3, the multiband antenna system 300 according to the third exemplary embodiment is an antenna system supporting three bands, including a plurality of broadband radiating elements 10, a plurality of branching filters 20, and a plurality of phase shifters 30.

Here, the branching filters 20 are connected to the plurality of broadband radiating elements 10 to correspond to each other on a one-to-one basis. Therefore, when the number of broadband radiating elements 10 is n, n branching filters 20 are used. The broadband radiating elements 10 according to the third exemplary embodiment support three bands. For example, the three bands may be selected from among an 800 MHz band, a 900 MHz band, a 1.8 GHz band, a 2.1 GHz band, and a 2.3 GHz band, but are not limited thereto. The multiband antenna system 300 according to the third exemplary embodiment includes first, second, . . . , n^{th} broadband radiating elements 11, 13, . . . , and 17.

As the branching filters 20, triplexers capable of separating the three bands can be used. For example, the multiband antenna system 300 according to the third exemplary embodiment includes first, second, . . . , n^{th} branching filters 21, 23, . . . , and 27.

The plurality of phase shifters 30 include first, second, and third band phase shifters 31, 33, and 35. The first band phase shifter 31 performs electrical tilting on a signal included in a first band among three bands separated by the plurality of branching filters 20. The second band phase shifter 33 performs electrical tilting on a signal included in a second band among the three bands separated by the plurality of branching filters 20. The third band phase shifter 35 performs electrical tilting on a signal included in a third band among the three bands separated by the plurality of branching filters 20. For example, the first band phase shifter 31 may perform a phase shift on a signal in a 700 MHz band, the second band phase shifter 33 may perform a phase shift on a signal in a 900 MHz band, and the third band phase shifter 35 may perform a phase shift on a signal in a 2.1 GHz band.

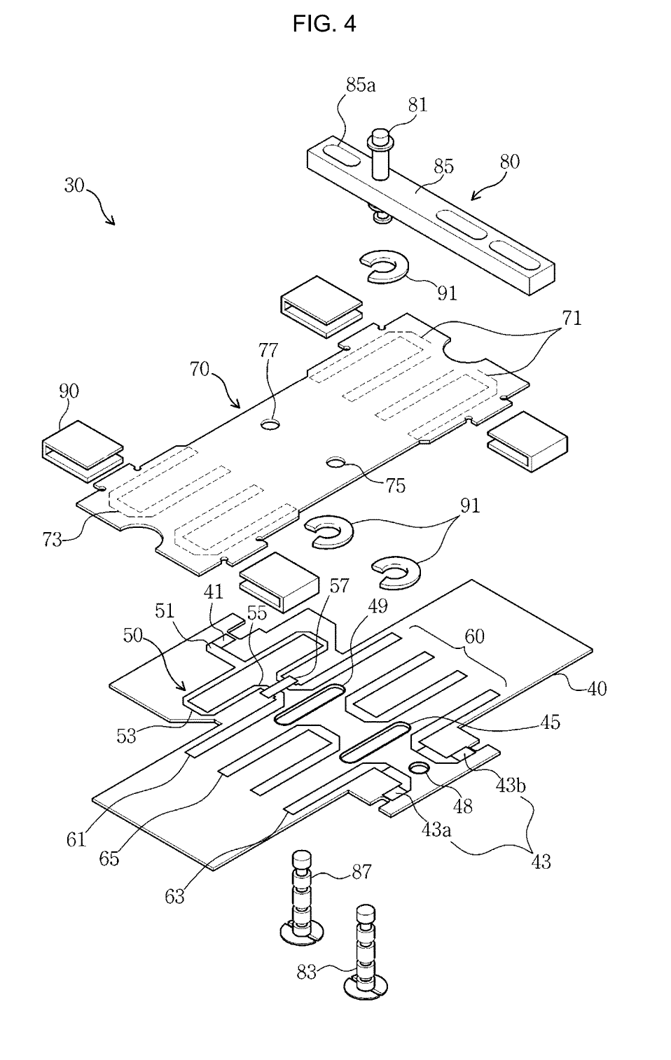

Phase shifters that can be applied to such a multiband antenna system according to the present invention will be described below with reference to FIGS. 4 to 17.

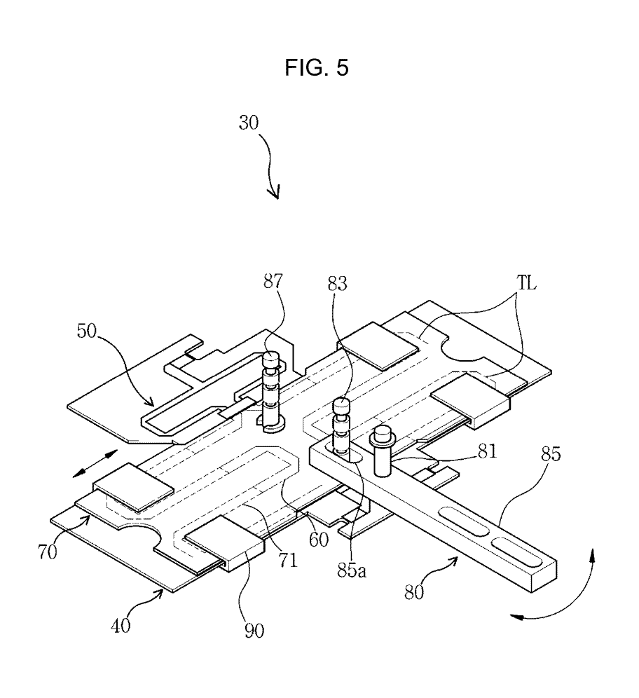

A phase shifter 30 according to the first exemplary embodiment will be described below with reference to FIGS. 4 and 5. FIG. 4 is an exploded perspective view of a first example of the phase shifter 30 that can be applied to a multiband antenna system according to the present invention, and FIG. 5 is a perspective view of the phase shifter 30 of FIG. 4.

Referring to FIGS. 4 and 5, the phase shifter 30 according to the first example includes a base substrate 40 and a variable substrate 70.

In the base substrate 40, an input port 41 and a plurality of output ports 43 are formed, and a plurality of first transmission lines 60 which connect the input port 41 with the plurality of output ports 43 through at least one Wilkinson divider 50 are discontinuously formed.

In the variable substrate 70, a plurality of second transmission lines 71 which are separately connected to the plurality of first transmission lines 60 to constitute continuous transmission lines TL are formed, and the variable substrate 70 is combined with the base substrate 40 and moves to change the lengths of the transmission lines TL between the input port 41 and the plurality of output ports 43.

The phase shifter 30 according to the first example may further include a moving member 80 that moves the variable substrate 70 with respect to the base substrate 40.

The phase shifter 30 according to the first example will be described in detail below.

The base substrate 40 has the input port 41 and the plurality of output ports 43. The base substrate 40 includes the at least one Wilkinson divider 50 connected to the input port 41. Each of the at least one Wilkinson divider 50 has two connection ports 55. At the two connection ports 55 of the Wilkinson divider 50, one pair of first transmission lines 60 are discontinuously formed to be symmetrical to each other. In the base substrate 40, the plurality of output ports 43 are separately connected to ends of the first transmission lines 60.

The variable substrate 70 is combined with the base substrate 40 to be movable, and the second transmission lines 71 which physically come in contact with the first transmission lines 60 to continuously connect the discontinuously formed first transmission lines 60 are formed in the variable substrate 70. According to movement of the variable substrate 70, the second transmission lines 71 overlap the first transmission lines 60 to change the lengths of the transmission lines TL between the input port 41 and the plurality of output ports 43.

As the base substrate 40 and the variable substrate 70, printed circuit boards (PCBs) can be used, and the first transmission lines 60 of the base substrate 40 and the second transmission lines 71 of the variable substrate 70 are formed on surfaces facing each other. In other words, when the first transmission lines 60 are formed on an upper surface of the base substrate 40, the second transmission lines 71 are formed on a lower surface of the variable substrate 70.

The Wilkinson divider 50 includes a first interconnection 51, the two connection ports 55, and a resistor 57. The first interconnection 51 is connected to the input port 41. The two connection ports 55 are separately formed at two second interconnections 53 which symmetrically branch from the first interconnection 51. The resistor 57 connects the two connection ports 55. Since the Wilkinson divider 50 connects the two connection ports 55 through the resistor 57 in this way, impedances of the two connection ports 55 are matched, and isolation between the two connection ports 55 is ensured.

In the Wilkinson divider 50, the two connection ports 55 are positioned adjacent to each other based on a point at which the first interconnection 51 branches, and the two connection ports 55 adjacent to each other are connected through the resistor 57. Accordingly, the second interconnections 53 connected from the branch point of the first interconnection 51 to the two connection ports 55 are formed to be symmetrical to each other with respect to the branch point. For example, one of the second interconnections 53 connected from the branch point of the first interconnection 51 to one of the two connection ports 55 may be formed in a “⊂” shape, and the other may be formed in a “⊃” shape.

As the phase shifter 30 according to the first example, an example including the one Wilkinson divider 50 has been disclosed. Therefore, in the Wilkinson divider 50, the first interconnection 51 is connected to the input port 41, and the one pair of first transmission lines 60 are separately connected to the second interconnections 53 extending from the two connection ports 55.

The one pair of first transmission lines 60 are formed to be symmetrical to each other on two sides based on the Wilkinson divider 50. The first transmission lines 60 include start transmission lines 61 and end transmission lines 63, and may include connecting transmission lines 65.

The start transmission lines 61 are connected to the second interconnections 53 extending from the connection ports 55 and extend in a horizontal direction. Here, the horizontal direction is a direction perpendicular to a direction in which the second interconnections 53 connected to the start transmission lines 61 are formed.

The end transmission lines 63 are formed in parallel with the start transmission lines 61, and connected to the output ports 43.

At least one connecting transmission line 65 is formed between a start transmission line 61 and an end transmission line 63, and formed in either of “⊂” and “⊃” shapes. For example, the connecting transmission lines 65 formed in the one pair of first transmission lines 60 are formed in “⊂” and “⊃” shapes to face each other.

When the first transmission lines 60 do not have the connecting transmission lines 65, the second transmission lines 71 connect the start transmission lines 61 and the end transmission lines 63 which are not connected, and have portions overlapping the start transmission lines 61 and the end transmission lines 63.

When the first transmission lines 60 have the connecting transmission lines 65, the second transmission lines 71 connect the start transmission lines 61, the connecting transmission lines 65, and the end transmission lines 63 which are not connected, and have portions overlapping the start transmission lines 61, the connecting transmission lines 65, and the end transmission lines 63.

The variable substrate 70 is physically combined with the upper surface of the base substrate 40, on which the first transmission lines 60 are formed, to be movable. Here, as members that couple the variable substrate 70 to the base substrate 40 to be movable, clips 90 having a “⊂” shape can be used. The clips 90 are combined with the variable substrate 70 and the base substrate 40 so that the variable substrate 70 and the base substrate 40 are fitted in the clips 90 and come in contact with each other, thereby coupling the variable substrate 70 to the base substrate 40. Even if the variable substrate 70 and the base substrate 40 are coupled together in this way, when force is applied in a direction of an interface between the base substrate 40 and the variable substrate 70, the variable substrate 70 moves with respect to the base substrate 40. During movement of the variable substrate 70, the plurality of clips 90 coupling the variable substrate 70 and the base substrate 40 function to guide the variable substrate 70.

For example, the one pair of first transmission lines 60 are formed as a plurality of lines in parallel in the horizontal direction based on the Wilkinson divider 50, and thus a portion of the base substrate 40 in which the one pair of first transmission lines 60 are formed is formed in an approximately rectangular shape. Accordingly, the variable substrate 70 also is formed in a rectangular shape to correspond to the portion in which the one pair of first transmission lines 60 are formed. The plurality of clips 90 are combined with the variable substrate 70 and the base substrate 40 in a direction perpendicular to a direction in which the first transmission lines 60 are formed, on the two sides based on the Wilkinson divider 50 so that the variable substrate 70 and the base substrate 40 are fitted in the clips 90 and come in contact with each other.

On the lower surface of the variable substrate 70, one pair of second transmission lines 71 are formed to correspond to the one pair of first transmission lines 60. A second transmission line 71 includes at least one overlapping transmission line 73 having a “c” or “a” shape to connect a discontinuously formed first transmission line 60. When the number of connecting transmission lines 65 is n (n is an integer equal to or larger than 0), there are n+1 overlapping transmission lines 73.

The overlapping transmission line 73 has a reverse shape of a connecting transmission line 65. For example, when the connecting transmission line 65 has a “⊃” shape, the overlapping transmission line 73 has a “⊂” shape. On the other hand, when the connecting transmission line 65 has a “⊂” shape, the overlapping transmission line 73 has a “⊃” shape.

Therefore, when the variable substrate 70 is combined with the base substrate 40, the first transmission lines 60 and the second transmission lines 71 each of which is discontinuously formed constitute the continuously formed transmission lines TL similar to a rectangular waveform. According to movement of the variable substrate 70, the second transmission lines 71 overlap the first transmission lines 60, and a difference in length is made between the transmission lines TL on the two sides based on the Wilkinson divider 50.

In this way, the phase shifter 30 according to the first example performs a phase shift using a difference in length between the one pair of transmission lines TL. A phase variance can be adjusted by adjusting the horizontal and vertical lengths of the first and second transmission lines 60 and 71, and even when the phase variance is increased, it is possible to minimize an increase in the size of the phase shifter 30.

The moving member 80 moves the variable substrate 70 in a linear direction parallel to a direction in which the start transmission lines 61 are formed with respect to the base substrate 40. The moving member 80 includes a rotation shaft 81, a moving shaft 83, and a moving bar 85. The rotation shaft 81 is installed in the base substrate 40 to be rotatable. The moving shaft 83 is installed in the variable substrate 70. The moving bar 85 connects the rotation shaft 81 and the moving shaft 83, and moves the moving shaft 83 in a linear direction based on the rotation shaft 81 by externally applied force.

Here, the rotation shaft 81 can be integrally formed with the moving bar 85, and rotatably coupled to a hole 48 formed in the base substrate 40.

The moving shaft 83 is installed to connect a guide hole 45 which is formed in parallel with the start transmission lines 61 formed in the horizontal direction in the base substrate 40 and a hole 75 formed in the variable substrate 70 to correspond to the guide hole 45. Accordingly, the moving shaft 83 linearly moves along the guide hole 45 according to operation of the moving bar 85.

The moving member 80 may further include a dummy shaft 87 installed in the variable substrate 70 spaced apart from the moving shaft 83. The dummy shaft 87 functions to help the moving shaft 83 with a stable linear movement, and may be installed as necessary. The dummy shaft 87 is installed to connect a dummy guide hole 49 which is formed in parallel with the guide hole 45 formed in the horizontal direction in the base substrate 40 and a dummy hole 77 formed in the variable substrate 70 to correspond to the dummy guide hole 49. Accordingly, the dummy shaft 87 linearly moves along the dummy guide hole 49 together with the moving shaft 83 according to operation of the moving bar 85.

The rotation shaft 81, the moving shaft 83, and the dummy shaft 87 are installed in the base substrate 40 or the variable substrate 70 to be rotatable by means of washers 91.

The rotation shaft 81 and the moving shaft 83 are combined with the moving bar 85, and the moving bar 85 rotates about the rotation shaft 81 within a predetermined angle range by externally applied force. Since the moving shaft 83 linearly moves according to rotation of the moving bar 85, a hole 85a with which the moving shaft 83 of the moving bar 85 is combined is formed to be long in consideration of a moving distance of the moving shaft 83. The moving bar 85 is formed to extend from the rotation shaft 81 in an opposite direction to a side on which the moving shaft 83 is installed. A transfer bar (not shown) which transfers externally applied force can be connected to the extended portion of the moving bar 85. To rotate the moving bar 85 more stably, the distance between the rotation shaft 81 and the portion to which the transfer bar is connected is longer than the distance between the rotation shaft 81 and the moving shaft 83.

In the disclosed first example, the moving bar is installed above the variable substrate 70, but may be installed under the base substrate.

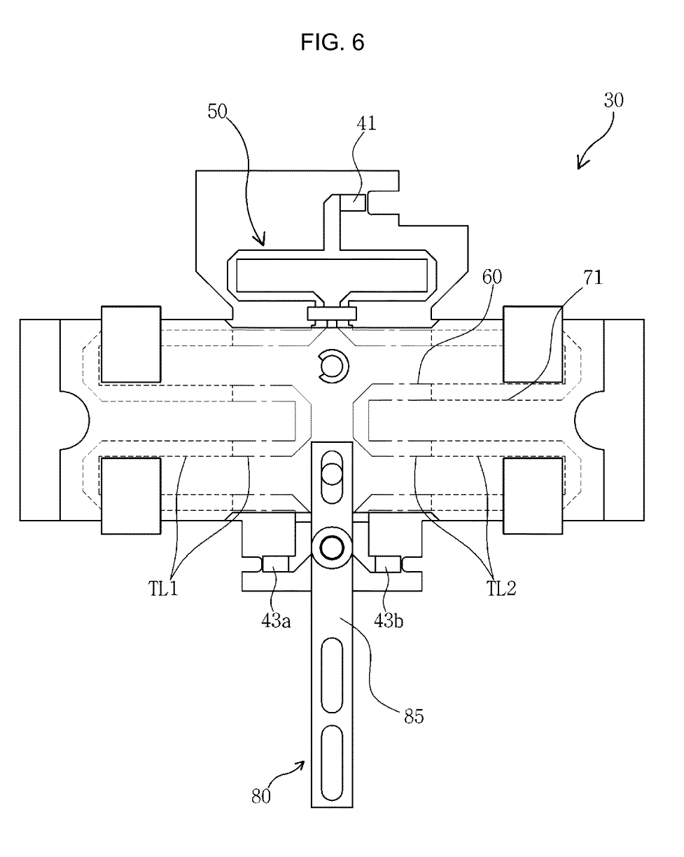

Examples of use of the phase shifter 30 according to the first example will be described below with reference to FIGS. 6 to 8. FIGS. 6 to 8 are diagrams showing examples of use of the phase shifter 30 of FIG. 5. In the drawings, one pair of output ports 43 include a first output port 43a positioned on the right and a second output port 43b positioned on the left. A transmission line connecting the input port 41 and the first output port 43a is denoted by TL1, and a transmission line connecting the input port 41 and the second output port 43b is denoted by TL2.

As shown in FIG. 6, when the moving bar 85 is positioned at the center, the transmission lines TL1 and TL2 respectively connecting the input port 41 to the first and second output ports 43a and 43b have the same length. In this state, no phase shift occurs.

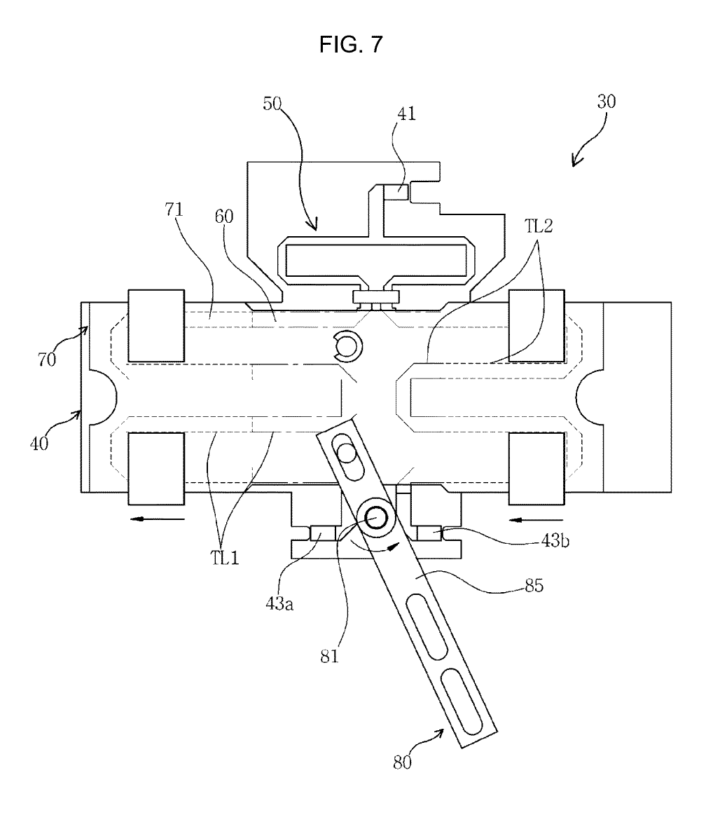

As shown in FIG. 7, when the moving bar 85 rotates counterclockwise about the rotation shaft 81, the variable substrate 70 moves to the left with respect to the base substrate 40.

Accordingly, the length of the transmission line TL1 connected to the first output port 43a increases, and the length of the transmission line TL2 connected to the second output port 43b decreases. Therefore, a signal input to the input port 41 is shifted in phase and output through the first and second output ports 43a and 43b. On the other hand, signals input to the first and second output ports 43a and 43b are shifted in phase and can be output through the input port 41.

Here, overlapping portions between the first and second transmission lines 60 and 71 on the side of the first output port 43a are reduced, and the length of the transmission line TL1 increases. On the other hand, overlapping portions between the first and second transmission lines 60 and 71 on the side of the second output port 43b extend, and the length of the transmission line TL2 decreases.

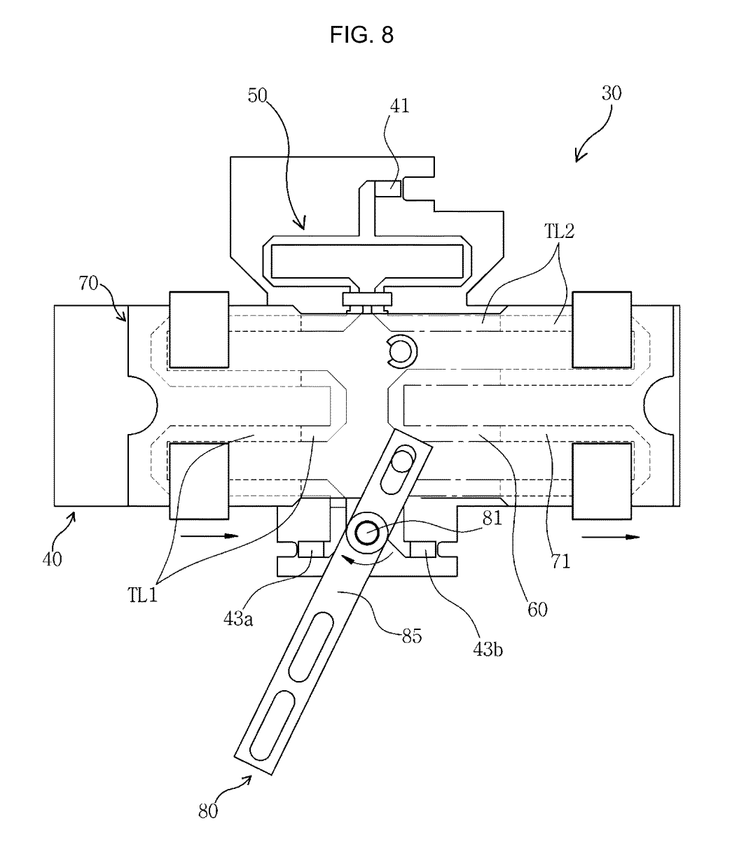

As shown in FIG. 8, when the moving bar 85 rotates clockwise about the rotation shaft 81, the variable substrate 70 moves to the right with respect to the base substrate 40.

Accordingly, the length of the transmission line TL2 connected to the second output port 43b increases, and the length of the transmission line TL1 connected to the first output port 43a decreases. Therefore, a signal input to the input port 41 is shifted in phase and output through the first and second output ports 43a and 43b. On the other hand, signals input to the first and second output ports 43a and 43b are shifted in phase and can be output through the input port 41.

Here, overlapping portions between the first and second transmission lines 60 and 71 on the side of the second output port 43b are reduced, and the length of the transmission line TL2 increases. On the other hand, overlapping portions between the first and second transmission lines 60 and 71 on the side of the first output port 43a extend, and the length of the transmission line TL1 decreases.

In this way, the phase shifter 30 according to the first example performs a phase shift on a signal input thereto according to changes of the lengths of the both transmission lines TL1 and TL2 dependent on clockwise or counterclockwise rotation of the moving bar 85.

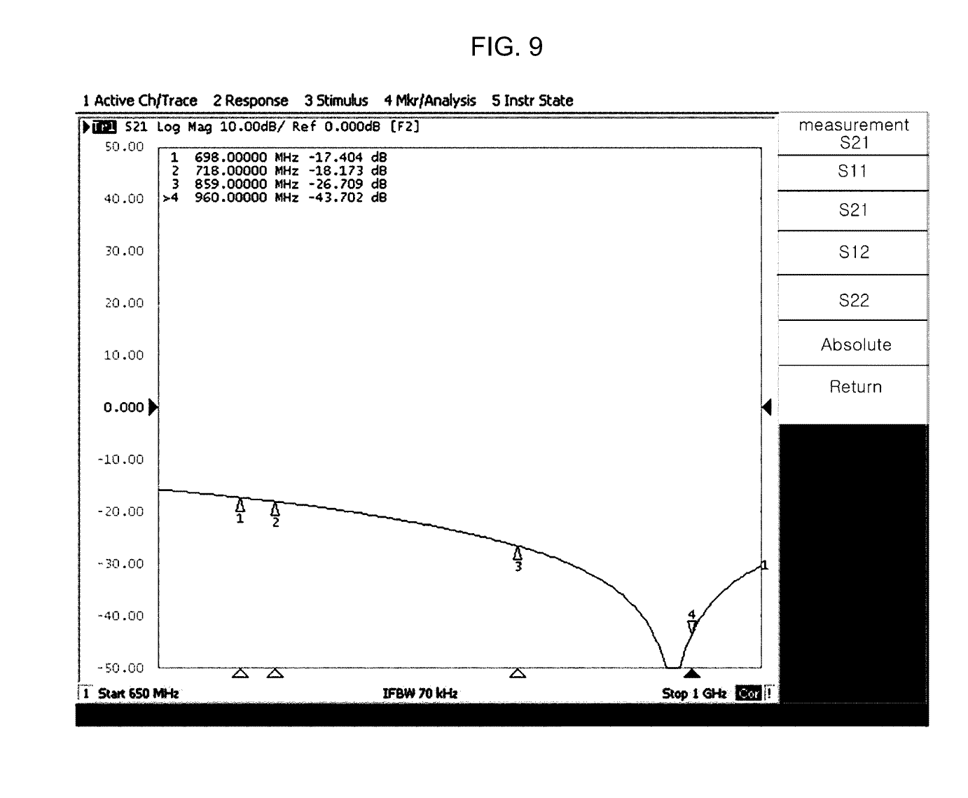

A scattering (S)-parameter of a multiband antenna system employing the phase shifter 30 according to the first example in a 700 MHz band and a 900 MHz band will be described below with reference to FIG. 9. Here, FIG. 9 is a graph showing an S-parameter of the multiband antenna system 200 of FIG. 2 in a 700 MHz band and a 900 MHz band.

Referring to FIG. 9, S21 represents isolation between output ports.

S21 is −17.404 dB at 698.000 MHz, −18.173 dB at 718.000 MHz, −26.709 dB at 859.000 MHz, and 43.702 dB at 960.000 MHz. In other words, it is possible to see that isolation between output ports is ensured because the multiband antenna system 200 according to the second exemplary embodiment employs a phase shifter having a Wilkinson divider.

It is possible to see that, in such a multiband antenna system employing a phase shifter according to the first example, an isolation characteristic between output ports is ensured even when a plurality of branching filters are connected to the phase shifter, but the isolation characteristic between output ports is not ensured when a plurality of branching filters are connected to a conventional arc-based phase shifter.

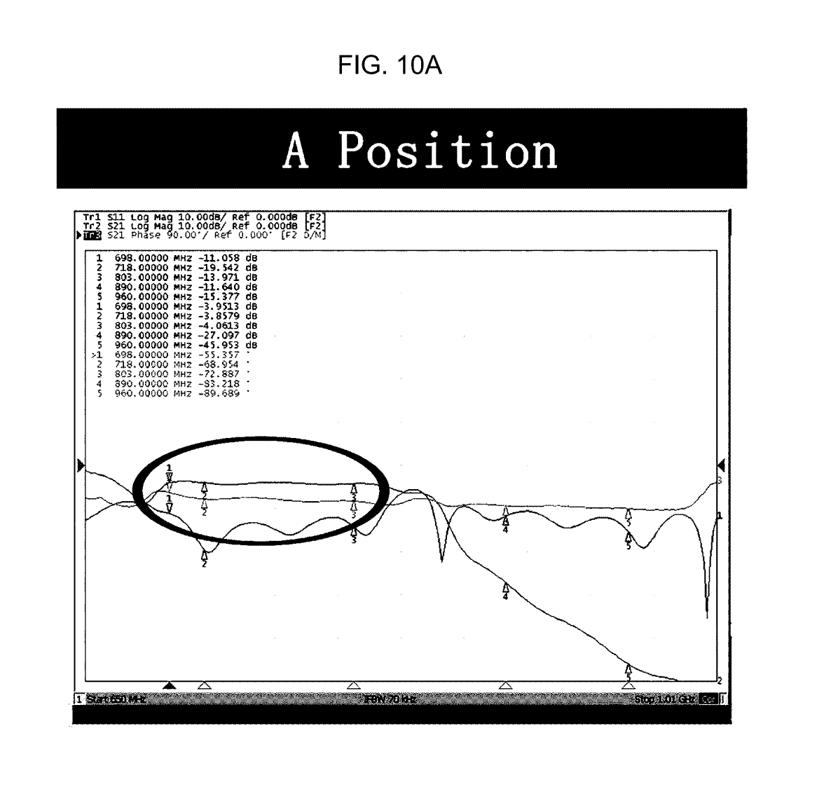

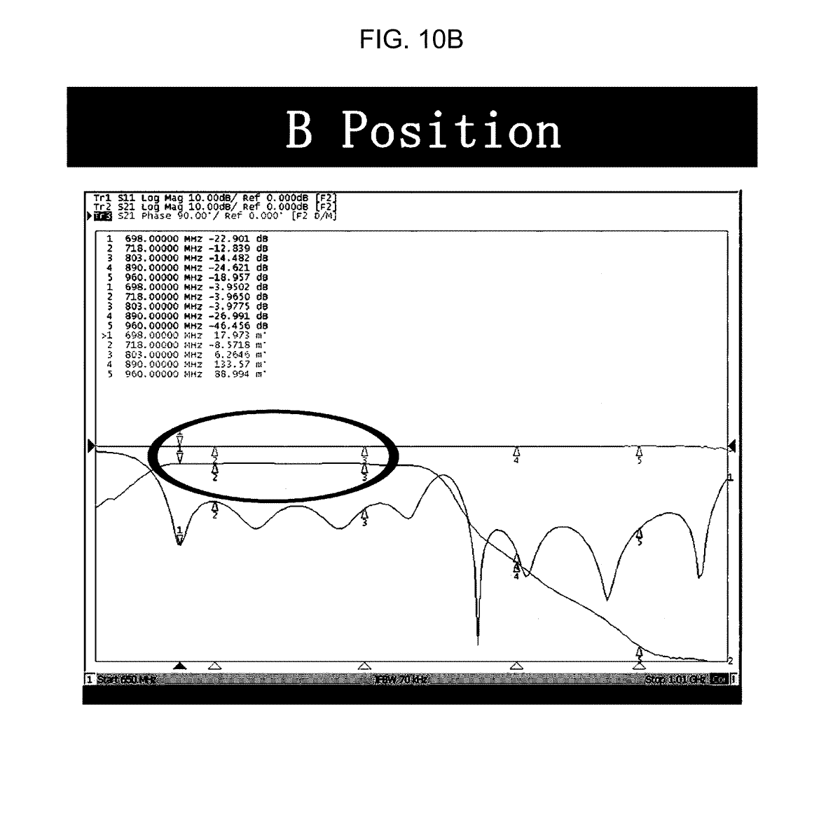

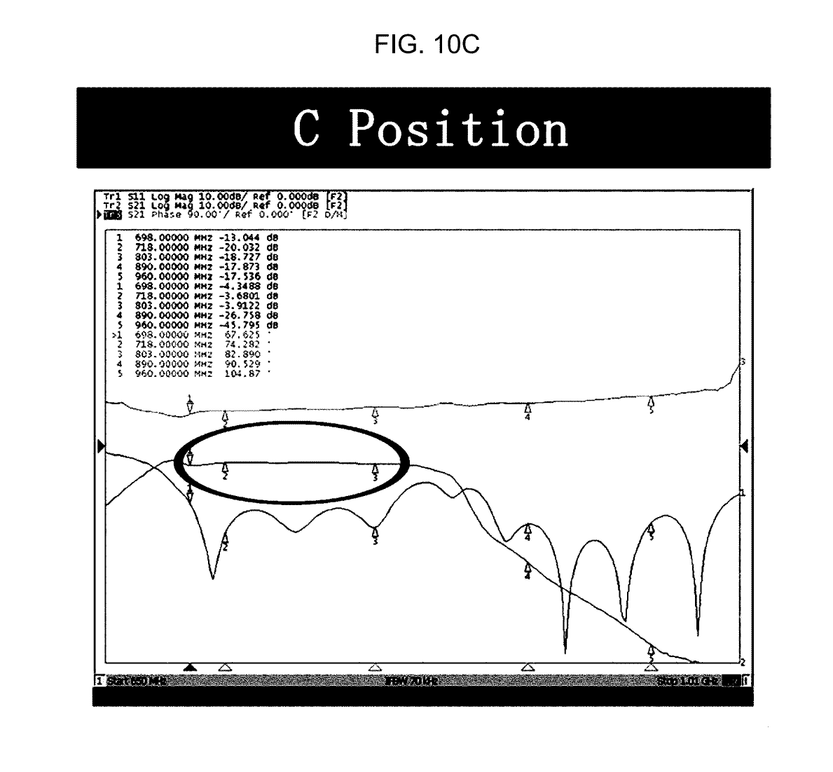

FIGS. 10A through 10C are graphs showing an S-parameter of a multiband antenna system employing an arc-based phase shifter according to a comparative example in a 700 MHz band.

Referring to FIG. 10A through 10C, a multiband antenna system according to a comparative example includes an arc-based phase shifter having one input port and two output ports and two branching filters separately installed at the two output ports of the arc-based phase shifter. A to C positions are positions of a body of rotation in the phase shifter. The B position represents a state in which the body of rotation is positioned at the center so that there is no phase shift. Also, the A position represents a state in which the body of rotation is moved to the right, and the C position represents a state in which the body of rotation is moved to the left.

When other components, that is, the branching filters, are connected to the arc-based phase shifter according to the comparative example, it is possible to see that a pass characteristic of the branching filters is distorted according to the position of the body of rotation in the arc-based phase shifter because isolation between the output ports is not ensured.

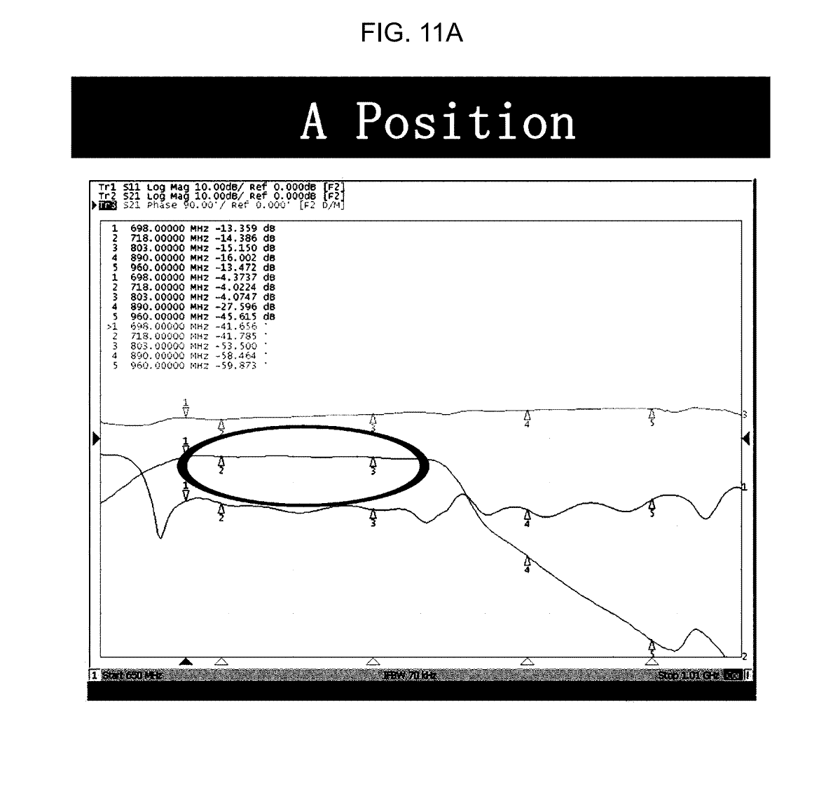

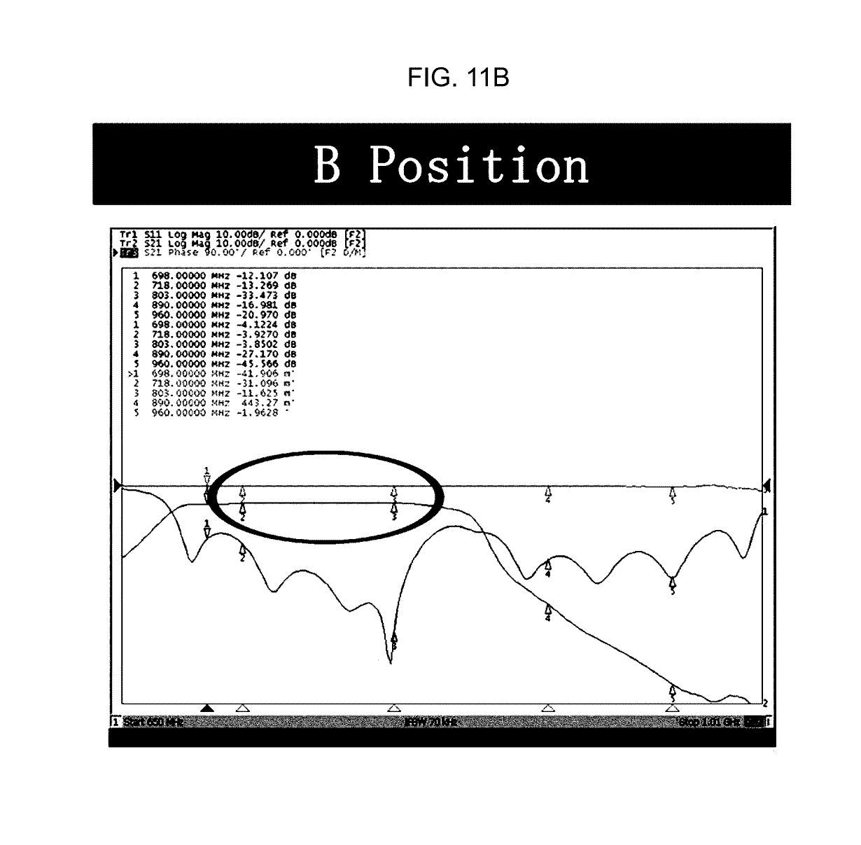

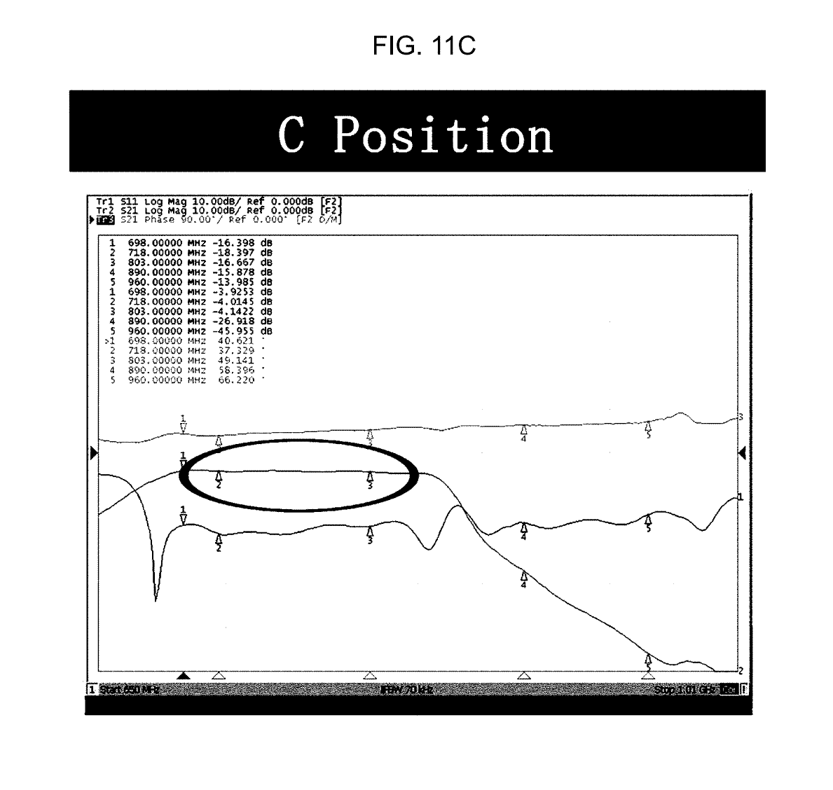

FIGS. 11A through 11C are graphs showing an S-parameter of a multiband antenna system employing the phase shifter according to the first example of the present invention in a 700 MHz band.

Referring to FIGS. 11A to 11C, a multiband antenna system according to the first example includes a phase shifter having one input port and two output ports and two branching filters separately installed at the two output ports of the phase shifter. A to C positions are positions of a moving bar in the phase shifter. The B position represents a state in which the moving bar is positioned at the center so that there is no phase shift (FIG. 6). The A position represents a state in which the moving bar is moved to the right (FIG. 7), and the C position represents a state in which the moving bar is moved to the left (FIG. 8).

It is possible to see that, even when the branching filters are connected to the phase shifter according to the first example, a pass characteristic of the branching filters is not distorted according to the position of the moving bar because isolation between the output ports is ensured.

In this way, in the phase shifter 30 according to the first example, the Wilkinson divider 50 is used to connect the input port 41 and the plurality of output ports 43, and thus it is possible to solve a problem of an arc-based phase shifter based on a T-junction. In other words, since the phase shifter 30 employs the Wilkinson divider 50, isolation between the respective output ports 43 can be ensured.

In the phase shifter 30 according to the first example, it is only necessary to increase the vertical and horizontal lengths of first and second transmission lines 60 and 71 so as to increase a phase variance. Therefore, even when the phase variance is increased, it is possible to minimize an increase in size.

In the phase shifter 30 according to the first example, it is possible to ensure isolation between the output ports 43 using the Wilkinson divider 50. Therefore, it is unnecessary to separately install phase shifters according to respective bands, and it is possible to cope with band broadening more effectively.

In the phase shifter 30 according to the first example, it is possible to ensure isolation between the output ports 43 using the Wilkinson divider 50. Therefore, it is possible to prevent a distortion of a unique characteristic of a component or a distortion of a phase signal even when the component is added to the back of the phase shifter 30.

In the phase shifter 30 according to the first example, it is possible to ensure isolation between the output ports 43 using the Wilkinson divider 50. Therefore, it is possible to solve the problem of a distorted amplitude and phase supplied to each radiating element even when the phase shifter 30 is applied to an array antenna.

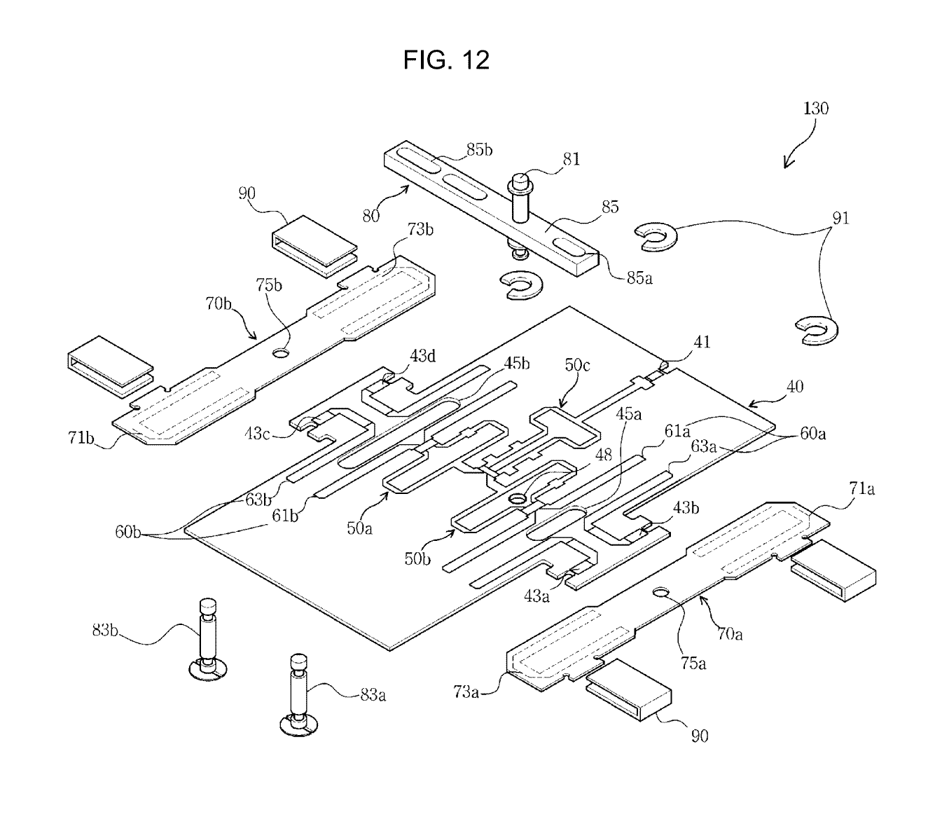

Meanwhile, the 3-port phase shifter 30 has been described in the first example, but a 5-port phase shifter 130 as shown in FIGS. 12 to 17 can be used when there are four branching filters 20.

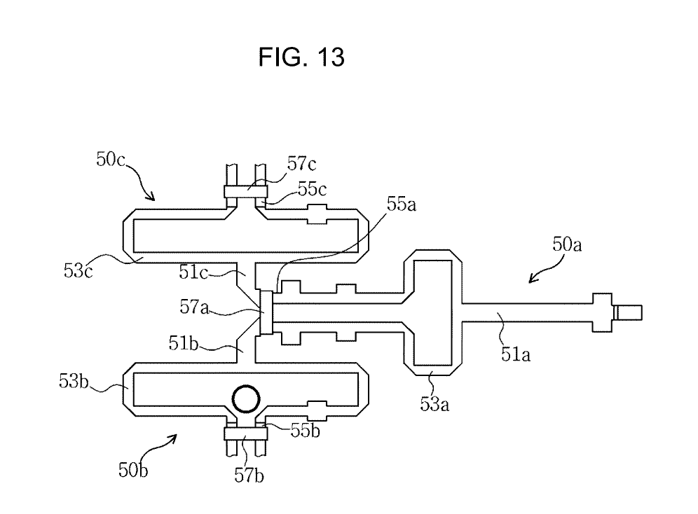

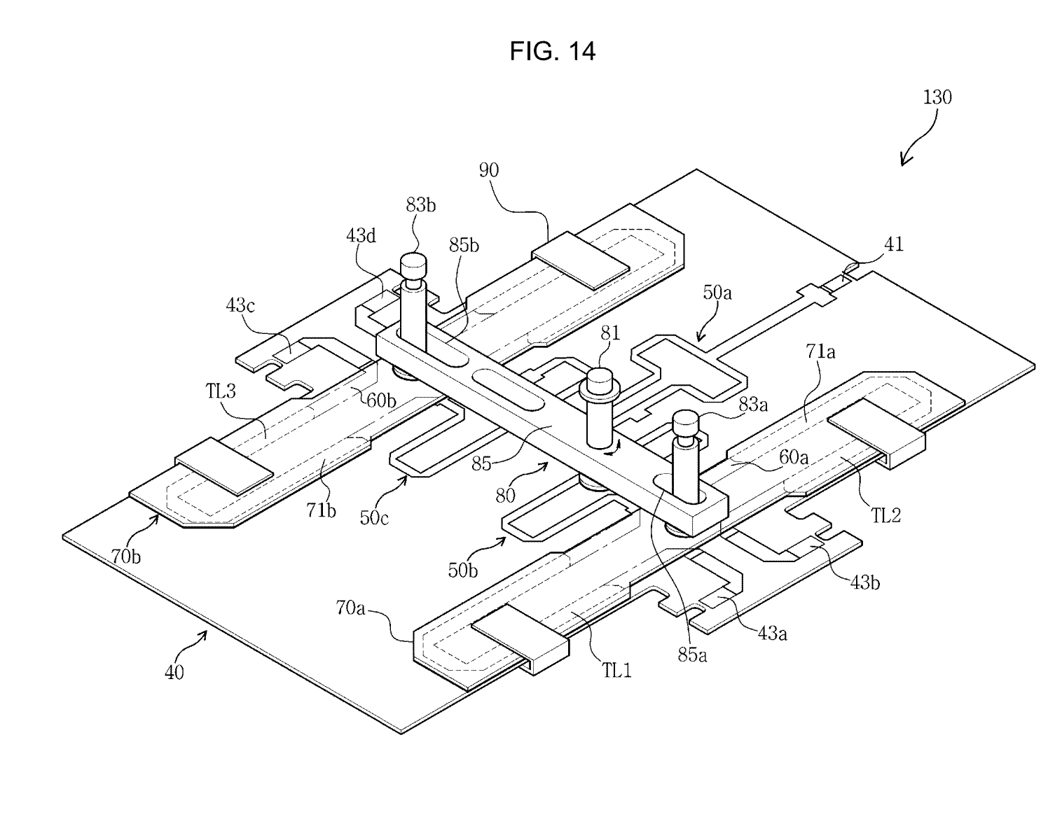

FIG. 12 is an exploded perspective view of the phase shifter 130 using Wilkinson dividers 50a, 50b, and 50c according to a second example of the present invention. FIG. 13 is an enlarged view of the Wilkinson dividers 50a, 50b, and 50c of FIG. 12. FIG. 14 is a perspective view of the phase shifter 130 of FIG. 12.

Referring to FIGS. 12 to 14, the phase shifter 130 according to the second example is a 5-port phase shifter, and includes the three Wilkinson dividers 50a, 50b, and 50c to have one input port 41 and four output ports 43a, 43b, 43c, and 43d. The phase shifter 130 according to the second example includes a base substrate 40 in which the three Wilkinson dividers 50a, 50b, and 50c are formed, and variable substrates 70a and 70b which are installed at the base substrate 40 to be movable.

The base substrate 40 includes the first to third Wilkinson dividers 50a, 50b, and 50c. Here, the first, second, and third Wilkinson dividers 50a, 50b, and 50c have the same structure as the Wilkinson divider 50 (of FIG. 5) according to the first example, and thus individual structural descriptions of the first to third Wilkinson dividers 50a, 50b, and 50c will be omitted.

A first interconnection 51a of the first Wilkinson divider 50a is connected to the input port 41, and first interconnections 51b and 51c of the second and third Wilkinson dividers 50b and 50c are separately connected to second interconnections 53a extending from two first connection ports 55a. One pair of 1-1^{st} transmission lines 61a are separately connected to second interconnections 53b extending from two second connection ports 55b of the second Wilkinson divider 50b. One pair of 1-2^{nd} transmission lines 61b are separately connected to second interconnections 53c extending from two third connection ports 55c of the third Wilkinson divider 50c.

In the base substrate 40, the second and third Wilkinson dividers 50b and 50c are formed to face each other on two sides based on the first Wilkinson divider 50a. Based on a direction in which the two first connection ports 55a of the first Wilkinson divider 50a are formed, the two second connection ports 55b of the second Wilkinson divider 50b are formed on one side, and the two third connection ports 55c of the third Wilkinson divider 50c are formed on the other side.

The variable substrates 70a and 70b include a first variable substrate 70a and a second variable substrate 70b. In the first variable substrate 70a, 2-1^{st} transmission lines 71a connected to the second Wilkinson divider 50b are formed. The second variable substrate 70b is separated from the first variable substrate 70a. In the second variable substrate 70b, 2-2^{nd} transmission lines 71b which are disposed symmetrically to the 2-1^{st} transmission lines 71a and connected to the third Wilkinson divider 50c are formed. Here, the second transmission lines 71a and 71b include the 2-1^{st} transmission lines 71a and the 2-2^{nd} transmission lines 71b.

One pair of 1-1^{st} transmission lines 60a are formed to be symmetrical to each other on two sides based on the second Wilkinson divider 50b. The 1-1^{st} transmission lines 60a include first start transmission lines 61a and first end transmission lines 63a, and may further include first connecting transmission lines.

The first start transmission lines 61a are connected to the second interconnections 53b extending from the second connection ports 55b and extend in a horizontal direction. Here, the horizontal direction is a direction perpendicular to a direction in which the second interconnections 53b connected to the first start transmission lines 61a are formed.

The first end transmission lines 63a are formed in parallel with the first start transmission lines 61a, and connected to the output ports 43a and 43b.

At least one first connecting transmission line can be formed between a first start transmission line 61a and a first end transmission line 63a, and formed in either of “⊂” and “⊃” shapes. For example, the first connecting transmission lines formed in the one pair of 1-1^{st} transmission lines 60a are formed in “⊂” and “⊃” shapes to face each other.

When the 1-1^{st} transmission lines 60a do not have the first connecting transmission lines, the 2-1^{st} transmission lines 71a connect the start transmission lines 61a and the end transmission lines 63a which are not connected, and have portions overlapping the start transmission lines 61a and the end transmission lines 63a.

When the 1-1^{st} transmission lines 60a have the first connecting transmission lines, the 2-1^{st} transmission lines 71a connect the start transmission lines 61a, the connecting transmission lines, and the end transmission lines 63a which are not connected, and have portions overlapping the start transmission lines 61a, the first connecting transmission lines, and the end transmission lines 63a.

One pair of 1-2^{nd} transmission lines 60b are formed to be symmetrical to each other on two sides based on the third Wilkinson divider 50c. The 1-2^{nd} transmission lines 60b include second start transmission lines 61b and second end transmission lines 63b, and may further include second connecting transmission lines.

The one pair of 1-2^{nd} transmission lines 60b are connected to the third Wilkinson divider 50c in the same way as the one pair of 1-1^{st} transmission lines 60a except that they are formed to be connected to the third Wilkinson divider 50c symmetrically to the one pair of 1-1^{st} transmission lines 60a, and thus detailed description thereof will be omitted.

Each of the variable substrates 70a and 70b is physically combined with the upper surface of the base substrate 40, on which the 1-1^{st} and 1-2^{nd} transmission lines 60a and 60b are formed, to be movable. Here, as members that couple the variable substrates 70a and 70b to the base substrate 40 to be movable, clips 90 having a “c” shape can be used. The clips 90 are combined with the variable substrate 70a or 70b and the base substrate 40 so that the variable substrate 70a or 70b and the base substrate 40 are fitted in the clips 90 and come in contact with each other, thereby coupling the variable substrates 70a and 70b to the base substrate 40. Even if the variable substrates 70a and 70b and the base substrate 40 are coupled together in this way, when force is applied in a direction of an interface between the base substrate 40 and the variable substrate 70a or 70b, the variable substrates 70a and 70b move with respect to the base substrate 40. During movement of the variable substrates 70a and 70b, the plurality of clips 90 coupling the variable substrate 70 and the base substrate 40 function to guide the variable substrates 70a and 70b.

Here, the first variable substrate 70a and the second variable substrate 70b are combined with the base substrate 40 in the same form, and thus a structure in which the first variable substrate 70a is combined with the base substrate 40 will be primarily described.

For example, the one pair of 1-1^{st} transmission lines 60a are formed as a plurality of lines in parallel in the horizontal direction based on the second Wilkinson divider 50b, and thus a portion of the base substrate 40 in which the one pair of 1-1^{st} transmission lines 60a are formed is formed in an approximately rectangular shape. Accordingly, the first variable substrate 70a also is formed in a rectangular shape to correspond to the portion in which the one pair of 1-1^{st} transmission lines 60a are formed. A plurality of clips 90 are combined with the first variable substrate 70a and the base substrate 40 in a direction perpendicular to a direction in which the 1-1^{st} transmission lines 60a are formed, on the two sides based on the second Wilkinson divider 50b so that the first variable substrate 70a and the base substrate 40 are fitted in the clips 90 and come in contact with each other.

In the same way as the first variable substrate 70a, the second variable substrate 70b also is installed at the base substrate 40 to be connected to the 1-2^{nd} transmission lines 60b of the base substrate 40.

On the lower surface of the first variable substrate 70a, one pair of 2-1^{st} transmission lines 71a are formed to correspond to the one pair of 1-1^{st} transmission lines 60a. A 2-1^{st} transmission line 71a includes at least one overlapping transmission line 73a having a “⊂” or “⊃” shape to connect a discontinuously formed 1-1^{st} transmission line 60a. When the number of first connecting transmission lines is n (n is an integer equal to or larger than 0), there are n+1 first overlapping transmission lines 73a.

The first overlapping transmission line 73a has a reverse shape of a first connecting transmission line. For example, when the first connecting transmission line has a “⊃” shape, the first overlapping transmission line 73a has a “⊂” shape. On the other hand, when the first connecting transmission line has a “⊂” shape, the first overlapping transmission line 73a has a “⊃” shape.

Therefore, when the first variable substrate 70a is combined with the base substrate 40, the 1-1^{st} transmission lines 60a and the 2-1^{st} transmission lines 71a each of which is discontinuously formed constitute shapes similar to a continuous rectangular waveform. According to movement of the first variable substrate 70a, the 2-1^{st} transmission lines 71a overlap the 1-1^{st} transmission lines 60a, and a difference in length is made between transmission lines TL1 and TL2 on the two sides based on the second Wilkinson divider 50b.

Also, when the second variable substrate 70b is combined with the base substrate 40, the 1-2^{nd} transmission lines 60b and the 2-2^{nd} transmission lines 71b each of which is discontinuously formed constitute shapes similar to a continuous rectangular waveform. According to movement of the second variable substrate 70b, the 2-2^{nd} transmission lines 71b overlap the 1-2^{nd} transmission lines 60b, and a difference in length is made between transmission lines TL3 and TL4 on the two sides based on the third Wilkinson divider 50c.

In this way, the phase shifter 130 according to the second example performs a phase shift using differences in length between the two pairs of transmission lines TL1 and TL2, and TL3 and TL4. A phase variance can be adjusted by adjusting the horizontal and vertical lengths of the 1-1^{st}, 1-2^{nd}, 2-1^{st}, and 2-2^{nd} transmission lines 60a, 60b, 71a, and 71b, and even when the phase variance is increased, it is possible to minimize an increase in the size of the phase shifter 130.

A moving member 80 moves the first and second variable substrates 70a and 70b in a linear direction parallel to a direction in which the first start transmission lines 61a are formed with respect to the base substrate 40. Here, the moving member 80 moves the first and second variable substrates 70a and 70b in opposite directions.

The moving member 80 includes a rotation shaft 81, a first moving shaft 83a, a second moving shaft 83b, and a moving bar 85. The rotation shaft 81 is installed in the base substrate 40 to be rotatable. The first moving shaft 83a is installed in the first variable substrate 70a. The second moving shaft 83b is installed in the second variable substrate 70b. The moving bar 85 connects the rotation shaft 81 and the first and second moving shafts 83a and 83b, and moves the moving shafts 83a and 83b in opposite linear directions based on the rotation shaft 81 by externally applied force.

The rotation shaft 81, the first moving shaft 83a, and the second moving shaft 83b are installed in the base substrate 40 or the variable substrate 70a or 70b to be rotatable by means of washers 91.

To change differently the lengths of the transmission lines TL1, TL2, TL3, and TL4 connected to the respective output ports 43a, 43b, 43c, and 43d, the rotation shaft 81, the first moving shaft 83a, and the second moving shaft 83b are positioned in the same line, and distances of the first and second moving shafts 83a and 83b from the rotation shaft 81 are different.

The first moving shaft 83a is installed to connect a first guide hole 45a which is formed in parallel with the first start transmission lines 61a formed in the horizontal direction in the base substrate 40 and a first hole 75a formed in the first variable substrate 70a to correspond to the first guide hole 45a.

The second moving shaft 83b is installed to connect a second guide hole 45b which is formed in parallel with the second start transmission lines 61b formed in the horizontal direction in the base substrate 40 and a second hole 75b formed in the second variable substrate 70b to correspond to the second guide hole 45b.

According to operation of the moving bar 85, the first and second moving shafts 83a and 83b linearly move in opposite directions along the first and second guide holes 45a and 45b.

The rotation shaft 81 and the first and second moving shafts 83a and 83b are combined with the moving bar 85, and the moving bar 85 rotates about the rotation shaft 81 within a predetermined angle range by externally applied force. Since the first and second moving shafts 83a and 83b linearly move in opposite directions according to rotation of the moving bar 85, holes 85a and 85b with which the first and second moving shafts 83a and 83b of the moving bar 85 are combined is formed to be long in consideration of moving distances of the first and second moving shafts 83a and 83b.

The moving bar 85 is formed above the second and third Wilkinson dividers 50b and 50c to ensure maximum moving distances to the left and the right. When there is no phase shift, the moving bar 85 can be positioned in the same line together with the second and third Wilkinson dividers 50b and 50c. The rotation shaft 81 is formed in either of the second and third Wilkinson dividers 50b and 50c.

The moving bar 85 rotates about the rotation shaft 81 by externally applied force, which may be applied to the second moving shaft 83b positioned a long distance away from the rotation shaft 81. Needless to say, the externally applied force may be applied to the first moving shaft 83a. In this case, the first moving shaft 83a has a shorter distance from the rotation shaft 81 than the second moving shaft 83b, and thus it is required to apply greater force than the force applied to the second moving shaft 83b.

In the disclosed second example, the moving bar 85 is installed above the variable substrate 70a, but may be installed under the base substrate 40.

The phase shifter 130 according to the second example has the same basic structure as the phase shifter 30 (of FIG. 5) according to the first example except that it employs the three Wilkinson dividers 50a, 50b, and 50c, and thus it is possible to expect the same effects as the phase shifter 30 (of FIG. 5) according to the first example.

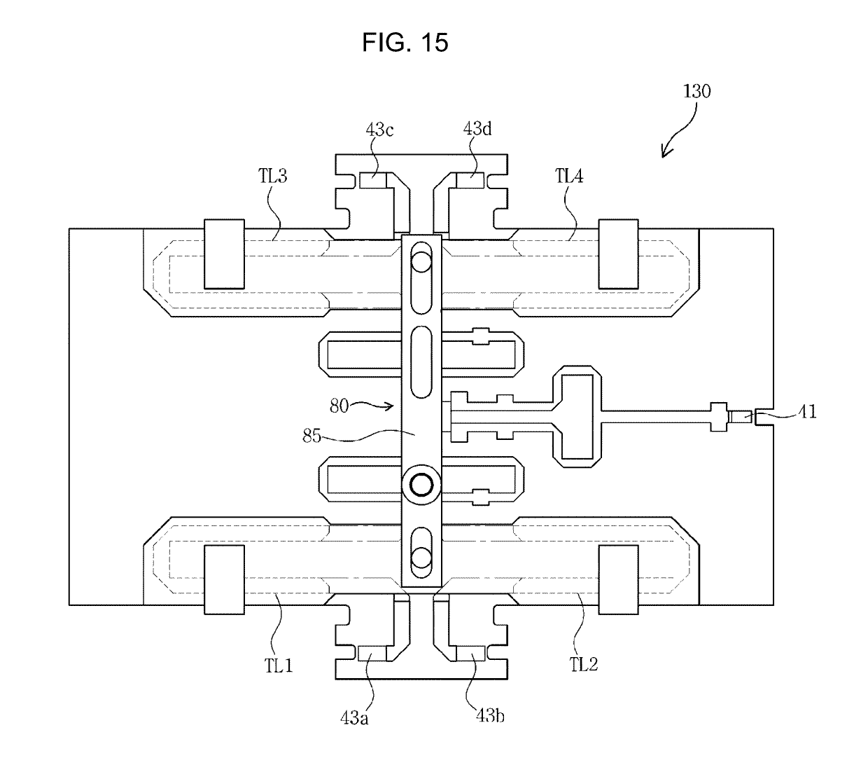

Examples of use of the phase shifter 130 according to the second example will be described below with reference to FIGS. 15 to 17. Here, FIGS. 15 to 17 are diagrams showing examples of use of the phase shifter 130 of FIG. 14. In the drawings, the four output ports 43a, 43b, 43c, and 43d include the first and second output ports 43a and 43b positioned at the lower side and the third and fourth output ports 43c and 43d positioned at the upper side. The first and third output ports 43a and 43c are positioned on the left, and the second and fourth output ports 43b and 43d are positioned on the right.

As shown in FIG. 15, when the moving bar 85 is positioned at the center, the transmission lines separately connected from the input port 41 to the first to fourth output ports 43a, 43b, 43c, and 43d have the same length.

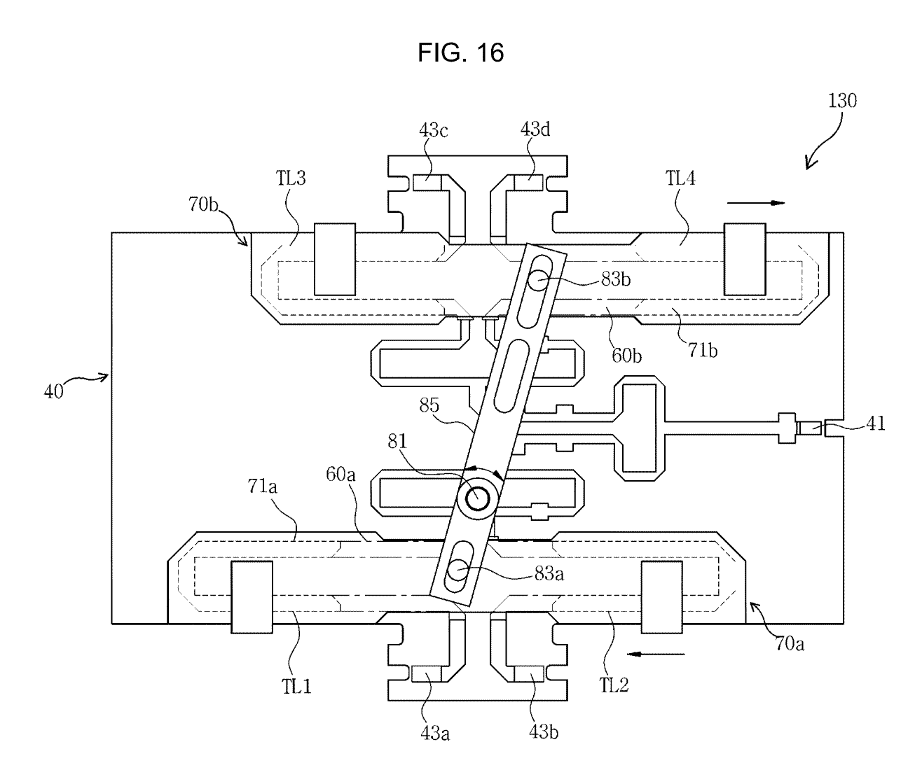

As shown in FIG. 16, when the moving bar 85 rotates clockwise about the rotation shaft 81, the first variable substrate 70a moves to the left with respect to the base substrate 40, and the second variable substrate 70b moves to the right with respect to the base substrate 40.

Accordingly, the length of the transmission line TL1 connected to the first output port 43a increases, and the length of the transmission line TL2 connected to the second output port 43b decreases. Therefore, a signal input to the input port 41 is shifted in phase and output through the first and second output ports 43a and 43b. On the other hand, signals input to the first and second output ports 43a and 43b are shifted in phase and can be output through the input port 41.

Here, overlapping portions between the 1-1^{st} and 2-1^{st} transmission lines 60a and 71a on the side of the first output port 43a are reduced, and the length of the transmission line TL1 increases. On the other hand, overlapping portions between the 1-1^{st} and 2-1^{st} transmission lines 60a and 71a on the side of the second output port 43b extend, and the length of the transmission line TL2 decreases.

The length of the transmission line TL3 connected to the third output port 43c decreases, and the length of the transmission line TL4 connected to the fourth output port 43d increases. Therefore, the signal input to the input port 41 is shifted in phase and output through the third and fourth output ports 43c and 43d. On the other hand, signals input to the third and fourth output ports 43c and 43d are shifted in phase and can be output through the input port 41.

Here, overlapping portions between the 1-2^{nd} and 2-2^{nd} transmission lines 60b and 71b on the side of the fourth output port 43d are reduced, and the length of the transmission line TL4 increases. On the other hand, overlapping portions between the 1-2^{nd} and 2-2^{nd} transmission lines 60b and 71b on the side of the third output port 43c extend, and the length of the transmission line TL3 decreases.

Since the distances of the first and second moving shafts 83a and 83b from the rotation shaft 81 are different, a difference in linear moving distance is made between the first and second variable substrates 70a and 70b. Therefore, all the lengths of the transmission lines TL1, TL2, TL3, and TL4 connected to the first, second, third, and fourth output ports 43a, 43b, 43c, and 43d are different. Consequently, a signal input to the input port 41 can be output as signals having different phases through the first to fourth output ports 43a, 43b, 43c, and 43d.

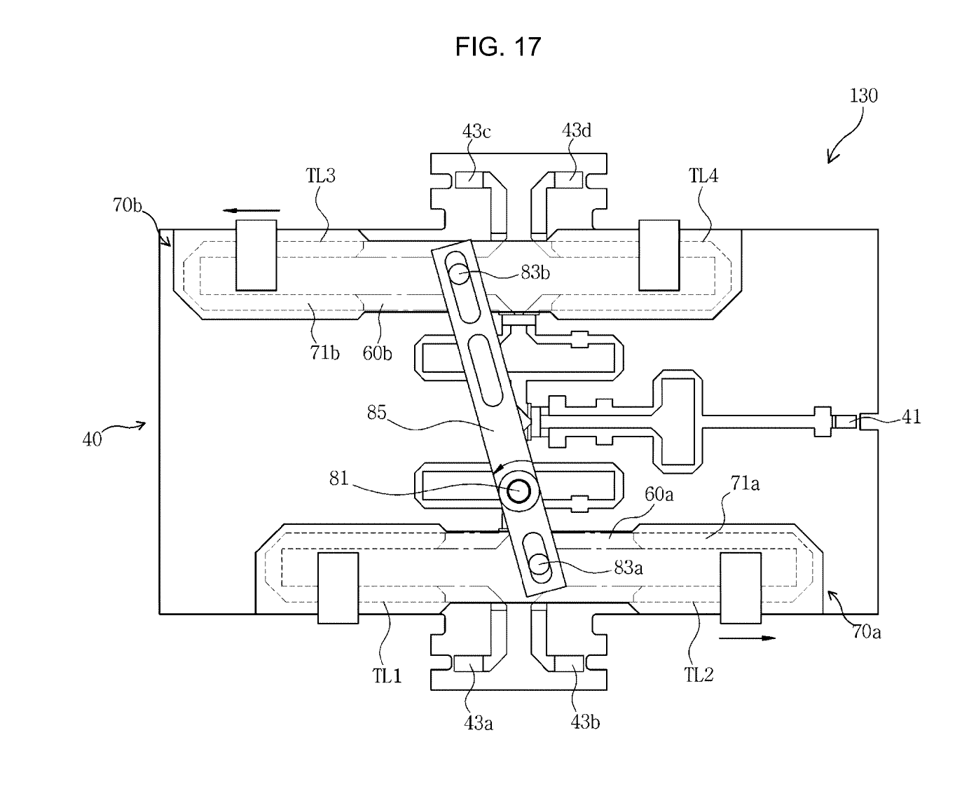

As shown in FIG. 17, when the moving bar 85 rotates counterclockwise about the rotation shaft 81, the first variable substrate 70a moves to the right with respect to the base substrate 40, and the second variable substrate 70b moves to the left.

Accordingly, the length of the transmission line TL2 connected to the second output port 43b increases, and the length of the transmission line TL1 connected to the first output port 43a decreases. Therefore, a signal input to the input port 41 is shifted in phase and output through the first and second output ports 43a and 43b. On the other hand, signals input to the first and second output ports 43a and 43b are shifted in phase and can be output through the input port 41.

Here, overlapping portions between the 1-1^{st} and 2-1^{st} transmission lines 60a and 71a on the side of the second output port 43b are reduced, and the length of the transmission line TL2 increases. On the other hand, overlapping portions between the 1-1^{st} and 2-1^{st} transmission lines 60a and 71a on the side of the first output port 43a extend, and the length of the transmission line TL1 decreases.

The length of the transmission line TL4 connected to the fourth output port 43d decreases, and the length of the transmission line TL3 connected to the third output port 43c increases. Therefore, the signal input to the input port 41 is shifted in phase and output through the third and fourth output ports 43c and 43d. On the other hand, signals input to the third and fourth output ports 43c and 43d are shifted in phase and can be output through the input port 41.

Here, overlapping portions between the 1-2^{nd} and 2-2^{nd} transmission lines 60b and 71b on the side of the third output port 43c are reduced, and the length of the transmission line TL3 increases. On the other hand, overlapping portions between the 1-2^{nd} and 2-2^{nd} transmission lines 60b and 71b on the side of the fourth output port 43d extend, and the length of the transmission line TL4 decreases.

Since the distances of the first and second moving shafts 83a and 83b from the rotation shaft 81 are different, a difference in linear moving distance is made between the first and second variable substrates 70a and 70b. Therefore, all the lengths of the transmission lines TL1, TL2, TL3, and TL4 connected to the first to fourth output ports 43a, 43b, 43c, and 43d are different. Consequently, a signal input to the input port 41 can be output as signals having different phases through the first to fourth output ports 43a, 43b, 43c, and 43d.

In this way, the phase shifter 130 according to the second example performs a phase shift on a signal input thereto according to changes of the lengths of the transmission lines TL1, TL2, TL3, and TL4, which are connected to the first to fourth output ports 43a, 43b, 43c, and 43d, dependent on clockwise or counterclockwise rotation of the moving bar 85.

Meanwhile, the exemplary embodiments of the present invention disclosed in the specification and the drawings merely propose specific examples in order to help in a thorough and complete understanding of the present invention and do not intend to limit the scope of the present invention. It is apparent to those of ordinary skill in the art that various modified embodiments based on the technical spirit of the present invention can be carried out, in addition to the embodiments disclosed herein.

1. A multiband antenna system comprising:
at least one broadband radiating element configured to support multiple bands;
a branching filter connected to each of the at least one broadband radiating element, and configured to branch band-specific signals included in the multiple bands; and
a plurality of phase shifters provided to correspond to a number of the multiple bands, and configured to perform beam tilting for the branched band-specific signals according to the respective bands.

2. The multiband antenna system of claim 1, wherein the branching filter is a diplexer or a triplexer.

3. The multiband antenna system of claim 2, wherein, when the broadband radiating element supports two bands, the branching filter is a diplexer or a triplexer, and
when the broadband radiating element supports three bands, the branching filter is a triplexer.

4. The multiband antenna system of claim 3, wherein, when the broadband radiating element supports two bands, the plurality of phase shifters include two phase shifters separately supporting the two bands, and
when the broadband radiating element supports three bands, the plurality of phase shifters include three phase shifters separately supporting the three bands.

5. The multiband antenna system of claim 1, wherein the plurality of phase shifters each comprise:
a base substrate in which an input port and a plurality of output ports are formed, and a plurality of first transmission lines connecting the input port with the plurality of output ports through at least one Wilkinson divider are discontinuously formed; and
a variable substrate in which a plurality of second transmission lines separately connected to the plurality of first transmission lines to constitute continuous transmission lines are formed, and which is combined with the base substrate and moves to change lengths of the transmission lines between the input port and the plurality of output ports.

6. The multiband antenna system of claim 5, wherein the base substrate comprises the input port, the plurality of output ports, and the at least one Wilkinson divider connected to the input port,
each of the at least one Wilkinson divider has two connection ports,
one pair of first transmission lines are discontinuously formed to be symmetrical to each other at the two connection ports in the base substrate, and
the plurality of output ports are separately connected to ends of the first transmission lines in the base substrate.

7. The multiband antenna system of claim 6, wherein the variable substrate is combined with the base substrate to be movable, and
second transmission lines physically coming in contact with the first transmission lines to continuously connect the discontinuously formed first transmission lines are formed in the variable substrate, and overlap the first transmission lines to change lengths of the transmission lines between the input port and the plurality of output ports according to movement of the variable substrate.

8. The multiband antenna system of claim 7, wherein the Wilkinson divider comprises:
a first interconnection to which a signal is input;
the two connection ports separately formed at two second interconnections symmetrically branching from the first interconnection; and
a resistor configured to connect the two connection ports.

9. The multiband antenna system of claim 8, wherein, in the Wilkinson divider, the two connection ports are positioned adjacent to each other based on a point at which the first interconnection branches, and
the two connection ports adjacent to each other are connected through the resistor.

10. The multiband antenna system of claim 9, wherein the base substrate includes one Wilkinson divider,
the first interconnection of the Wilkinson divider is connected to the input port, and
the one pair of first transmission lines are separately connected to the second interconnections extending from the two connection ports.

11. The multiband antenna system of claim 9, wherein the base substrate includes first to third Wilkinson dividers,
the first interconnection of the first Wilkinson divider is connected to the input port,
the first interconnections of the second and third Wilkinson dividers are separately connected to the second interconnections extending from the two connection ports of the first Wilkinson divider,
one pair of 1-1^{st} transmission lines are separately connected to the second interconnections extending from the two connection ports of the second Wilkinson divider, and
one pair of 1-2^{nd} transmission lines are separately connected to the second interconnections extending from the two connection ports of the third Wilkinson divider.
